(19) United States
(12) Patent Application Publication
(10) Pub. No.: US 2025/0105350 A1
(43) Pub. Date: Mar. 27, 2025

(54) SOLID ELECTROLYTE AND ELECTRICITY STORAGE DEVICE INCLUDING THE SAME

(71) Applicant: Panasonic Intellectual Property Management Co., Ltd., Osaka (JP)

(72) Inventors: Eiichi KOGA, Hokkaido (JP); Yoshiko HIGASHI, Osaka (JP)

(21) Appl. No.: 18/977,151

(22) Filed: Dec. 11, 2024

Related U.S. Application Data
(63) Continuation of application No. PCT/JP2023/016978, filed on Apr. 28, 2023.

(30) Foreign Application Priority Data
Jun. 17, 2022 (JP) 2022-098336
Jun. 29, 2022 (JP) 2022-105043

(51) Int. Cl. H01M 10/0562; H01M 4/38

(52) U.S. Cl. CPC H01M 10/0562; H01M 4/38; H01M 2300/0077

(57) ABSTRACT

A solid electrolyte according to the present disclosure contains Li, Pr, Zr, O, and M and includes a crystalline phase having a garnet-type crystal structure, wherein the M is at least one selected from the group consisting of Sb, Bi, As, Ge, and Te. An electricity storage device according to the present disclosure may be, for example, a battery. The battery includes a positive electrode, a negative electrode, and an electrolyte layer provided between the positive electrode and the negative electrode. At least one selected from the group consisting of the positive electrode, the negative electrode, and the electrolyte layer may include the solid electrolyte according to the present disclosure.

This application is a continuation of PCT/JP2023/016978 filed on Apr. 28, 2023, which claims foreign priority of Japanese Patent Applications No. 2022-098336 filed on Jun. 17, 2022 and No. 2022-105043 filed on Jun. 29, 2022, the entire contents of both of which are incorporated herein by reference.

### BACKGROUND OF THE INVENTION

### 1. Field of the Invention

The present disclosure relates to a solid electrolyte and an electricity storage device including the same.

### 2. Description of Related Art

JP 2020-095934 A discloses an oxide solid electrolyte having a garnet-type crystal structure containing Pr and an electricity storage device including the same.

The present disclosure aims to provide a novel solid electrolyte suitable for use in electricity storage devices.

### SUMMARY OF THE INVENTION

A solid electrolyte of the present disclosure contains Li, Pr, Zr, O, and M and includes a crystalline phase having a garnet-type crystal structure, wherein the M is at least one selected from the group consisting of Sb, Bi, As, Ge, and Te. The present disclosure provides a novel solid electrolyte suitable for use in electricity storage devices.

### BRIEF DESCRIPTION OF THE DRAWINGS

FIG. 1 is a cross-sectional view of a battery 1000 according to a second embodiment.

FIG. 2 is a cross-sectional view of a battery 2000 according to a modification of the second embodiment.

### DETAILED DESCRIPTION

### Outline of One Aspect According to the Present Disclosure

A solid electrolyte according to a first aspect of the present disclosure contains Li, Pr, Zr, O, and M and includes a crystalline phase having a garnet-type crystal structure, wherein
the M is at least one selected from the group consisting of Sb, Bi, As, Ge, and Te.

The solid electrolyte according to the first aspect is a novel solid electrolyte suitable for electricity storage devices.

In a second aspect of the present disclosure, for example, the solid electrolyte according to the first aspect may be such that the M includes Sb.

The solid electrolyte according to the second aspect is a novel solid electrolyte suitable for electricity storage devices.

In a third aspect of the present disclosure, for example, the solid electrolyte according to the second aspect may be represented by the following composition formula:

Li₇₍₁₊ₓ₁₎α1₃β1₂₊ₐ₁Sb_{y1}O_{12+3.5x1+1.5y1+b1} (1)
where
α1 includes Pr,
β1 includes Zr, and
−0.05≤x1≤0.35, 0<y1≤0.5, −0.5≤a1≤0.5, and −0.5≤b1≤0.5 are satisfied.

According to the third aspect, a solid electrolyte having practical ionic conductivity can be provided. Moreover, the thermal shock resistance of the solid electrolyte is improved.

In a fourth aspect of the present disclosure, for example, the solid electrolyte according to the third aspect may be such that in the composition formula (1), 0≤x1≤0.35 is satisfied.

According to the fourth aspect, the ionic conductivity of the solid electrolyte is improved.

In a fifth aspect of the present disclosure, for example, the solid electrolyte according to the third or fourth aspect may be such that in the composition formula (1), 0≤x1≤0.3 is satisfied.

According to the fifth aspect, the ionic conductivity of the solid electrolyte is further improved.

In a sixth aspect of the present disclosure, for example, the solid electrolyte according to any one of the third to fifth aspects may be such that in the composition formula (1), 0<x1≤0.3 is satisfied.

According to the sixth aspect, the ionic conductivity of the solid electrolyte is further improved.

In a seventh aspect of the present disclosure, for example, the solid electrolyte according to any one of the third to sixth aspects may be such that a molar ratio of Pr to the entire α1 is 0.8 or more, and a molar ratio of Zr to the entire β1 is 0.8 or more.

According to the seventh aspect, the sintering temperature for the solid electrolyte can be reduced. Moreover, the ionic conductivity and atmospheric stability of the solid electrolyte can be improved.

In an eighth aspect of the present disclosure, for example, the solid electrolyte according to any one of the third to seventh aspects may be such that the α1 is Pr, and the β1 is Zr.

According to the eighth aspect, the sintering temperature for the solid electrolyte can be further reduced. Moreover, the ionic conductivity and atmospheric stability of the solid electrolyte can be improved.

In a ninth aspect of the present disclosure, for example, the solid electrolyte according to any one of the third to eighth aspects may be such that in the composition formula (1), a1=0 and b1=0 are satisfied.

According to the ninth aspect, the sintering temperature for the solid electrolyte can be further reduced. Moreover, the ionic conductivity and atmospheric stability of the solid electrolyte can be improved.

In a tenth aspect of the present disclosure, for example, the solid electrolyte according to any one of the second to ninth aspects may be such that the crystalline phase has a cubic-system garnet-type crystal structure.

According to the tenth aspect, the ionic conductivity of the solid electrolyte is further improved.

In an eleventh aspect of the present disclosure, for example, the solid electrolyte according to any one of the second to tenth aspects may have a density of 2.7 g/cm³ or more and 4.2 g/cm³ or less.

According to the eleventh aspect, the ionic conductivity of the solid electrolyte is further improved.

In a twelfth aspect of the present disclosure, for example, the solid electrolyte according to the first aspect may be such that the M includes Bi.

The solid electrolyte according to the twelfth aspect is a novel solid electrolyte suitable for electricity storage devices.

In a thirteenth aspect of the present disclosure, for example, the solid electrolyte according to the twelfth aspect may be represented by the following composition formula (2):

Li₇₍₁₊ₓ₂₎α2₃β2₂₊ₐ₂Bi_{y2}O_{12+3.5x2+1.5y2+b2} (2)
where
α2 includes Pr,
β2 includes Zr, and
−0.05≤x2≤0.35, 0<y2≤0.4, −0.5≤a2≤0.5, and −0.5≤b2≤0.5 are satisfied.

According to the thirteenth aspect, a solid electrolyte having practical ionic conductivity can be provided. Moreover, the plating resistance of the solid electrolyte is improved. As used herein, plating resistance refers to resistance to corrosion caused by a plating solution.

In a fourteenth aspect of the present disclosure, for example, the solid electrolyte according to the thirteenth aspect may be such that in the composition formula (2), 0≤x2≤0.35 is satisfied.

According to the fourteenth aspect, the ionic conductivity of the solid electrolyte is improved.

In a fifteenth aspect of the present disclosure, for example, the solid electrolyte according to the thirteenth or fourteenth aspect may be such that in the composition formula (2), 0≤x2≤0.3 is satisfied.

According to the fifteenth aspect, the ionic conductivity of the solid electrolyte is further improved.

In a sixteenth aspect of the present disclosure, for example, the solid electrolyte according to any one of the thirteenth to fifteenth aspects may be such that in the composition formula (2), 0<x2≤0.3 is satisfied.

According to the sixteenth aspect, the ionic conductivity of the solid electrolyte is further improved.

In a seventeenth aspect of the present disclosure, for example, the solid electrolyte according to any one of the thirteenth to sixteenth aspects may be such that a molar ratio of Pr to the entire a2 is 0.8 or more, and a molar ratio of Zr to the entire β2 is 0.8 or more.

According to the seventeenth aspect, the sintering temperature for the solid electrolyte can be reduced. Moreover, the ionic conductivity and atmospheric stability of the solid electrolyte can be improved.

In an eighteenth aspect of the present disclosure, for example, the solid electrolyte according to any one of the thirteenth to seventeenth aspects may be such that the α2 is Pr, and the β2 is Zr.

According to the eighteenth aspect, the sintering temperature for the solid electrolyte can be further reduced. Moreover, the ionic conductivity and atmospheric stability of the solid electrolyte can be improved.

In a nineteenth aspect of the present disclosure, for example, the solid electrolyte according to any one of the thirteenth to eighteenth aspects may be such that in the composition formula (2), a2=0 and b2=0 are satisfied.

According to the nineteenth aspect, the sintering temperature for the solid electrolyte can be further reduced. Moreover, the ionic conductivity and atmospheric stability of the solid electrolyte can be improved.

In a twentieth aspect of the present disclosure, for example, the solid electrolyte according to any one of the twelfth to nineteenth aspects may be such that the crystalline phase has a cubic-system garnet-type crystal structure.

According to the twentieth aspect, the ionic conductivity of the solid electrolyte is further improved.

In a twenty-first aspect of the present disclosure, for example, the solid electrolyte according to any one of the twelfth to twentieth aspects may have a density of 3.76 g/cm³ or more and 4.27 g/cm³ or less.

According to the twenty-first aspect, the ionic conductivity of the solid electrolyte is further improved.

An electricity storage device according to a twenty-second aspect of the present disclosure includes:
a first electrode;
a second electrode; and
the solid electrolyte according any one of the first to twenty-first aspects.

According to the twenty-second aspect, an electricity storage device having excellent performance and also exhibiting excellent stability can be achieved.

In a twenty-third aspect of the present disclosure, for example, the electricity storage device according to the twenty-second aspect may be such that at least one selected from the group consisting of the first electrode and the second electrode includes a metal having a melting point of less than 1050° C.

According to the twenty-third aspect, at least one selected from the group consisting of the first electrode and the second electrode can be formed from a highly electrically conductive metal with high Ag content and from an inexpensive metal with low Pd and Pt contents.

In a twenty-fourth aspect of the present disclosure, for example, the electricity storage device according to the twenty-third aspect may be such that the metal is a Ag—Pd alloy.

According to the twenty-fourth aspect, an electricity storage device having excellent performance can be achieved at low cost.

In a twenty-fifth aspect of the present disclosure, for example, the electricity storage device according to any one of the twenty-second to twenty-fourth aspects may be such that at least one selected from the group consisting of the first electrode and the second electrode is composed of a Ag—Pd alloy, and a molar ratio of Ag to Pd in the Ag—Pd alloy is more than 80/20.

According to the twenty-fifth aspect, an electricity storage device having excellent performance can be achieved at low cost.

In a twenty-sixth aspect of the present disclosure, for example, the electricity storage device according to the twenty-second or twenty-third aspect may be such that at least one selected from the group consisting of the first electrode and the second electrode is composed of Ag.

According to the twenty-sixth aspect, the electricity storage device has sufficient electrical conductivity and excellent atmospheric stability. Therefore, with the above configuration, an electricity storage device having excellent performance can be achieved at low cost.

In a twenty-seventh aspect of the present disclosure, for example, the electricity storage device according to any one of the twenty-second to twenty-sixth aspects may be a battery or a multilayer capacitor.

According to the twenty-seventh aspect, a battery or multilayer capacitor having excellent performance and also exhibiting excellent stability can be achieved.

In a twenty-eighth aspect of the present disclosure, for example, the electricity storage device according to the twenty-seventh aspect may be such that the electricity storage device is a battery, the battery further includes an electrolyte layer provided between the first electrode and the second electrode, and at least one selected from the group consisting of the first electrode, the second electrode, and the electrolyte layer includes the solid electrolyte.

According to the twenty-eighth aspect, a battery having excellent performance and excellent stability is provided.

In a twenty-ninth aspect of the present disclosure, for example, the electricity storage device according to the twenty-eighth aspect may be such that the electrolyte layer includes the solid electrolyte.

According to the twenty-ninth aspect, the performance and stability of the battery are improved.

A method for manufacturing a solid electrolyte according to a thirtieth aspect of the present disclosure includes:
mixing raw materials including an oxide containing Li, an oxide containing Pr, an oxide containing Zr, and an oxide of M;
obtaining a compact of a mixture resulting from the mixing; and
sintering the compact, wherein
the M is at least one selected from the group consisting of Sb, Bi, As, Ge, and Te.

According to the thirtieth aspect, a novel solid electrolyte suitable for use in electricity storage devices can be manufactured.

In a thirty-first aspect of the present disclosure, for example, the manufacturing method according to the thirtieth aspect may be such that the M includes Sb.

According to the thirty-first aspect, a novel solid electrolyte suitable for use in electricity storage devices can be manufactured.

In a thirty-second aspect of the present disclosure, for example, the manufacturing method according to the thirtieth aspect may be such that the M includes Bi.

According to the thirty-second aspect, a novel solid electrolyte suitable for use in electricity storage devices can be manufactured.

Embodiments of the present disclosure are described below with reference to the drawings.

### First Embodiment

A solid electrolyte according to a first embodiment contains Li, Pr, Zr, O, and M and includes a crystalline phase having a garnet-type crystal structure. M is at least one selected from the group consisting of Sb, Bi, As, Ge, and Te.

The solid electrolyte according to the first embodiment is a novel solid electrolyte suitable for use in electricity storage devices. Since the solid electrolyte according to the first embodiment contains Li, Pr, Zr, O, and M, the solid electrolyte can be formed by sintering at a low temperature of, for example, less than 1050° C. Consequently, the solid electrolyte has atmospheric stability.

The solid electrolyte according to the first embodiment, even when formed by sintering a compact at a low temperature of, for example, less than 1050° C., has practical ionic conductivity required for use in electricity storage devices. The solid electrolyte according to the first embodiment, for example, can have high ionic conductivity. Here, high ionic conductivity is, for example, 5.8×10⁻⁶ S/cm or more at near room temperature. Additionally, even in the case where the solid electrolyte according to the first embodiment is formed by sintering a compact at a temperature, for example, lower than the temperatures for solid electrolytes having a conventional Pr-containing garnet-type crystal structure, the solid electrolyte according to the first embodiment can have ionic conductivity comparable to the ionic conductivities of solid electrolytes having a conventional Pr-containing garnet-type crystal structure. The compact is described in detail below.

The solid electrolyte according to the first embodiment can be obtained by sintering at a temperature, for example, lower than the melting points of Ag-based metals, which have higher electrical conductivity and are more inexpensive than Ag—Pd alloys used as electrode materials in solid electrolytes having a conventional Pr-containing garnet-type crystal structure. The molar ratio of Ag to Pd in conventionally used Ag—Pd alloys is, for example, 70/30 to 60/40. A Ag-based metal having higher electrical conductivity than conventionally used Ag—Pd alloys is, for example, a Ag—Pd alloy containing 80% or more Ag, a Ag—Pt alloy containing 80% or more Ag, or a simple substance of Ag. The melting points of these Ag-based metals are lower than the melting points of conventionally used Ag—Pd alloys, for example, 1050° C. The solid electrolyte according to the first embodiment can be obtained by sintering at a temperature of, for example, 940° C. to 1040° C. Therefore, the solid electrolyte according to the first embodiment can also be obtained by sintering simultaneously with a simple substance of Ag, which has high electrical conductivity and a low melting point. The melting point of Ag is approximately 960° C.

The solid electrolyte according to the first embodiment can be formed by sintering a compact at a low temperature. As used herein, to distinguish from typical compacts, a compact used to obtain the solid electrolyte according to the first embodiment may hereinafter be referred to as “a compact according to the first embodiment”. In other words, the compact according to the first embodiment is sintered to obtain the solid electrolyte according to the first embodiment.

Since the solid electrolyte according to the first embodiment can be formed by sintering the compact according to the first embodiment at a low temperature, the compact according to the first embodiment can be sintered together with a metal having a low melting point. The solid electrolyte according to the first embodiment can be formed by sintering the compact according to the first embodiment at a temperature of, for example, less than 1050° C. An example of a metal having a low melting point of less than 1050° C. is a Ag—Pd alloy where the molar ratio of Ag to Pd is approximately 80/20 or more and less than 100/0. Furthermore, an example of a metal having a low melting point of 1000° C. or less is a Ag—Pd alloy where the molar ratio of Ag to Pd is approximately 90/10, or Ag. Additionally, the sintering temperature for the solid electrolyte according to the first embodiment is lower than the melting point of Au (approximately 1060° C.) and the melting point of Cu (approximately 1080° C.), enabling co-sintering with these high-electrical-conductivity conductors. Thus, co-sintering with high-electrical-conductivity conductor electrodes leads to the achievement of a high-performance electricity storage device with low loss.

M may be at least one selected from the group consisting of Sb, Bi, As, and Te.

M may include Sb. In other words, the solid electrolyte according to the first embodiment may contain Li, Pr, Zr, O, and Sb and include a crystalline phase having a garnet-type crystal structure. The solid electrolyte containing Li, Pr, Zr, O, and Sb is a novel solid electrolyte suitable for use in electricity storage devices. The solid electrolyte containing Li, Pr, Zr, O, and Sb can be formed by sintering at a low temperature of, for example, less than 1050° C. Consequently, the solid electrolyte has atmospheric stability. M may be Sb.

The solid electrolyte according to the first embodiment may be represented by the following composition formula (1):

Li₇₍₁₊ₓ₁₎α1₃β1₂₊ₐ₁Sb_{y1}O_{12+3.5x1+1.5y1+b1} (1)
where α1 includes Pr, β1 includes Zr, and −0.05≤x1≤0.35, 0<y1≤0.5, −0.5≤ a1≤0.5, and −0.5≤b1≤0.5 are satisfied.

Since the solid electrolyte represented by the composition formula (1) is an oxide solid electrolyte, the solid electrolyte represented by the composition formula (1) is free of sulfur, unlike sulfide solid electrolytes. Therefore, the solid electrolyte represented by the composition formula (1) has such high stability that the solid electrolyte does not generate hydrogen sulfide when exposed to the atmosphere. Owing to this high stability, the solid electrolyte represented by the composition formula (1) can be suitably used in electricity storage devices that are manufactured and used in the atmosphere.

Controlling the Sb content enables the solid electrolyte represented by the composition formula (1) to have a lower sintered density than the sintered densities of oxide solid electrolytes having a conventional Pr-containing garnet-type crystal structure, while high ionic conductivity is maintained. In general, as the sintered density decreases, that is, as the porosity increases, the heat capacity decreases. This leads to the suppression of structural defects such as cracks caused by thermal cycling and thermal shock generated from soldering during mounting. This effective action of containing Sb improves the thermal shock resistance of the solid electrolyte.

By setting the value of y1 in the composition formula (1) to a range of more than 0 and 0.5 or less, it is possible to perform sintering at less than 1050° C. without significant degradation in ionic conductivity. Furthermore, the value of y1 may be 0.1 or more and 0.5 or less. The above configuration enables sintering at 940° C. or more and less than 1050° C., with high electrical conductivity and reliability. Moreover, by increasing the value of y1 within a range of 0.5 or less, it is possible to adjust the sintered density of the solid electrolyte according to the first embodiment to a low value while maintaining high ionic conductivity, at a sintering temperature of 940° C. to 950° C. (e.g., temperature equal to or lower than the melting point of Ag). For example, the solid electrolyte represented by the composition formula (1) can be adjusted to have a sintered density of 2.7 g/cm³ to 4.2 g/cm³ while maintaining an ionic conductivity of 1×10⁻⁵ S/cm to 1×10⁻⁴ S/cm.

As used herein, “sintering temperature” refers to the temperature at which the compact according to the first embodiment is sintered to form the solid electrolyte. The sintering temperature is defined as the temperature at which the change in shrinkage of the compact according to the first embodiment reaches its maximum (the highest level of shrinkage) when the temperature is increased during sintering of the compact. The sintering temperature is roughly set as the midpoint temperature in the temperature range where the shrinkage rate shows its maximum value (typically, the difference between the minimum and maximum temperatures in this range is approximately 10° C.). Additionally, the temperature curve of the shrinkage rate can be determined by actually firing samples at various firing temperatures and obtaining the dependence on the dimensional change rate of the sintered body. The temperature curve of the shrinkage rate can also be determined from the changes observed in a firing profile using a thermal analyzer, such as a thermomechanical analyzer (TMA).

In the composition formula (1), the composition ratio of Li, α1, and β1 does not need to be a stoichiometric composition ratio.

In the composition formula (1), 0≤x1≤0.35 or 0≤x1≤0.3 may be satisfied. In the case where the value of x1 is 0 or more, the ionic conductivity of the solid electrolyte according to the first embodiment is improved.

In the composition formula (1), 0<x1≤0.35 or 0<x1≤0.3 may be satisfied. In the case where the value of x1 exceeds 0, the Li content in the solid electrolyte increases and consequently the sintering temperature further decreases. This enables formation and sintering of a cubic-system garnet-type crystal structure at lower firing temperatures, thereby increasing the ionic conductivity. In particular, in the case where the value of x1 is 0.3 or less, the ionic conductivity is further improved. High Li content causes a fusion issue of the solid electrolyte. However, in the case where the value of x1 is 0.3 or less, the occurrence of this fusion issue is suppressed. Furthermore, since the Li content is not overly excessive, the occurrence of Li deficiency in the crystal structure and a decrease in electrical conductivity are suppressed.

In the composition formula (1), α1 may include an element other than Pr. An example of the element other than Pr is a rare-earth element, such as La, Nd, or Sm. β1 may include an element other than Zr. An example of the element other than Zr is Al, Nb, Ta, Hf, or Bi.

To improve the ionic conductivity and atmospheric stability and to further decrease the temperature at which the compact according to the first embodiment is sintered, the molar ratio of Pr to the entire α1 may be 0.8 or more and the molar ratio of Zr to the entire β1 may be 0.8 or more. To further improve the ionic conductivity and atmospheric stability and to further decrease the temperature at which the compact according to the first embodiment is sintered, α1 may be Pr and β1 may be Zr.

In the composition formula (1), the values of a1 and b1 may both be 0. In the case where the values of a1 and b1 are both 0, the solid electrolyte according to the first embodiment has a crystal structure in which neither a deficiency of β1 nor a deficiency of oxygen is included. This can increase the ionic conductivity and atmospheric stability and decrease the sintering temperature. The deficiency of β1 is, for example, a deficiency of Zr.

The crystalline phase included in the solid electrolyte according to the first embodiment may have a cubic-system garnet-type crystal structure. In the case where the crystalline phase has a cubic-system garnet-type crystal structure, the solid electrolyte according to the first embodiment has further improved ionic conductivity even with low density, that is, even with a reduced effective electrically conductive area.

The solid electrolyte according to the first embodiment may include a crystalline phase having a crystal structure other than the cubic-system garnet-type crystal structure.

The solid electrolyte according to the first embodiment may form a solid solution of the cubic-system garnet-type crystal structure. For example, the solid electrolyte according to the first embodiment may be composed of a single phase of the cubic-system garnet-type crystal structure. The phrase “a solid electrolyte is composed of a single phase of a cubic-system garnet-type crystal structure” means that this solid electrolyte is determined to be composed of a single phase of the cubic-system garnet-type crystal structure on the basis of an X-ray diffraction result. Therefore, the solid electrolyte may include other crystalline phases that are not detectable even at the lowest detection sensitivity level of X-ray diffraction.

In the case where M is Sb and the solid electrolyte according to the first embodiment is composed of a single phase of a cubic-system garnet-type crystal structure, the solid electrolyte, with a low density of 2.7 g/cm³ to 4.2 g/cm³, has high ionic conductivity, for example, comparable to the ionic conductivities of solid electrolytes having a conventional Pr-containing garnet-type crystal structure, and has an ionic conductivity of, for example, 1×10⁻⁴ S/cm or more at room temperature. Solid electrolytes having a conventional Pr-containing garnet-type crystal structure have a density of 3.3 g/cm³ to 4.5 g/cm³. As used herein, the term “room temperature” refers to 25° C. in one example. In the case where the solid electrolyte according to the first embodiment is composed of a single phase of a cubic-system garnet-type crystal structure, its properties do not change even over a long time of, for example, 500 hours. For example, the absolute value of the percentage change in the ionic conductivity after 500 hours may be 3% or less. Consequently, the solid electrolyte has excellent atmospheric stability. With the above configuration, for example, the solid electrolyte, in the form of a sintered body having a low density (e.g., porosity of 10% to 50%) with many pores, still has high ionic conductivity and excellent atmospheric stability.

The solid electrolyte according to the first embodiment in which M is Sb may have a density of 2.1 g/cm³ or more and 4.2 g/cm³ or less or 2.7 g/cm³ or more and 4.2 g/cm³ or less. In the case where the solid electrolyte has a density of 2.7 g/cm³ or more and 4.2 g/cm³ or less, the ionic conductivity is further improved. In one example, the solid electrolyte having a density of 2.7 g/cm³ or more and 4.2 g/cm³ or less can have a sintering temperature equal to or lower than the melting point of Ag and have an ionic conductivity of 1×10⁻⁵ S/cm or more at room temperature.

M may include Bi. In other words, the solid electrolyte according to the first embodiment may contain Li, Pr, Zr, O, and Bi and include a crystalline phase having a garnet-type crystal structure. The solid electrolyte containing Li, Pr, Zr, O, and Bi is a novel solid electrolyte suitable for use in electricity storage devices. The solid electrolyte containing Li, Pr, Zr, O, and Bi can be formed by sintering at a low temperature of, for example, less than 1050° C. Consequently, the solid electrolyte has atmospheric stability. M may be Bi.

The solid electrolyte according to the first embodiment may be represented by the following composition formula (2):

Li₇₍₁₊ₓ₂₎α2₃β2₂₊ₐ₂Bi_{y2}O_{12+3.5x2+1.5}y2+b2 (2)
where α2 includes Pr, β2 includes Zr, and −0.05≤x2≤0.35, 0<y2≤0.4, −0.5≤ a2≤0.5, and −0.5≤b2≤0.5 are satisfied.

Since the solid electrolyte represented by the composition formula (2) is an oxide solid electrolyte, the solid electrolyte according to the first embodiment is free of sulfur, unlike sulfide solid electrolytes. Therefore, the solid electrolyte represented by the composition formula (2) has such high stability that the solid electrolyte does not generate hydrogen sulfide when exposed to the atmosphere. Owing to this high stability, the solid electrolyte represented by the composition formula (2) can be suitably used in electricity storage devices that are manufactured and used in the atmosphere.

Controlling the Bi content achieves high sintered density and high electrical conductivity. In chip components, terminal electrodes are typically plated with solder. However, in the case where a solid electrolyte in the form of a sintered body has many pores (i.e., low apparent density), the sintered body is prone to erosion due to an increased area in contact with a plating solution (acidic or alkaline). This tends to cause reliability issues related to a decrease in the mechanical strength of the sintered body and in the bonding strength of the terminal electrodes. For this reason, the sintered body to which plating is to be applied should be dense. In other words, the solid electrolyte should have high sintered density. This improves the plating resistance of the solid electrolyte. This effective action of containing Bi improves the mechanical strength of the devices with plating applied to the solid electrolyte and the bonding strength of the terminal electrodes, thereby achieving an electricity storage device with excellent mounting reliability.

By setting the value of y2 in the composition formula (2) to a range of more than 0 and 0.4 or less, it is possible to perform sintering at less than 1050° C. without significant degradation in ionic conductivity. Furthermore, the value of y2 may be 0.1 or more and 0.4 or less. The above configuration enables sintering at 940° C. or more and less than 1050° C., with high electrical conductivity and plating resistance. Moreover, by increasing the value of y2 within a range of 0.4 or less, it is possible to adjust the sintered density of the solid electrolyte according to the first embodiment to a high value while maintaining high ionic conductivity, at a sintering temperature of 940° C. to 950° C. (e.g., temperature equal to or lower than the melting point of Ag). For example, the solid electrolyte represented by the composition formula (2) can be adjusted to have a sintered density of 3.37 g/cm³ to 4.27 g/cm³ while maintaining an ionic conductivity of 1×10⁻⁵ S/cm to 1×10⁻⁴ S/cm.

In the composition formula (2), the composition ratio of Li, α2, and β2 does not need to be a stoichiometric composition ratio.

In the composition formula (2), 0≤x2≤0.35 or 0≤x2≤0.3 may be satisfied. In the case where the value of x2 is 0 or more, the ionic conductivity of the solid electrolyte according to the first embodiment is improved.

In the composition formula (2), 0<x2≤0.35 or 0<x2≤0.3 may be satisfied. In the case where the value of x2 exceeds 0, the Li content in the solid electrolyte increases and consequently the sintering temperature further decreases. This enables formation and sintering of a cubic-system garnet-type crystal structure at lower firing temperatures, thereby increasing the ionic conductivity. In particular, in the case where the value of x2 is 0.3 or less, the ionic conductivity is further improved. High Li content causes a fusion issue of the solid electrolyte. However, in the case where the value of x2 is 0.3 or less, the occurrence of this fusion issue is suppressed. Furthermore, since the Li content is not overly excessive, the occurrence of Li deficiency in the crystal structure and a decrease in electrical conductivity are suppressed.

In the composition formula (2), α2 may include an element other than Pr. An example of the element other than Pr is a rare-earth element, such as La, Nd, or Sm. β2 may include an element other than Zr. An example of the element other than Zr is Al, Nb, Ta, or Hf.

To improve the ionic conductivity and atmospheric stability and to further decrease the temperature at which the compact according to the first embodiment is sintered, the molar ratio of Pr to the entire α2 may be 0.8 or more and the molar ratio of Zr to the entire β2 may be 0.8 or more. To further improve the ionic conductivity and atmospheric stability and to further decrease the temperature at which the compact according to the first embodiment is sintered, α2 may be Pr and β2 may be Zr.

In the composition formula (2), the values of a2 and b2 may both be 0. In the case where the values of a2 and b2 are both 0, the solid electrolyte according to the first embodiment has a crystal structure in which neither a deficiency of β2 nor a deficiency of oxygen is included. This can increase the ionic conductivity and atmospheric stability and decrease the sintering temperature. The deficiency of β2 is, for example, a deficiency of Zr.

The crystalline phase included in the solid electrolyte according to the first embodiment may have a cubic-system garnet-type crystal structure. In the case where the crystalline phase has a cubic-system garnet-type crystal structure, the solid electrolyte according to the first embodiment achieves high sintered density and high ionic conductivity.

The solid electrolyte according to the first embodiment may include a crystalline phase having a crystal structure other than the cubic-system garnet-type crystal structure.

The solid electrolyte according to the first embodiment may form a solid solution of the cubic-system garnet-type crystal structure. For example, the solid electrolyte according to the first embodiment may be composed of a single phase of the cubic-system garnet-type crystal structure. The phrase “a solid electrolyte is composed of a single phase of a cubic-system garnet-type crystal structure” means that this solid electrolyte is determined to be composed of a single phase of the cubic-system garnet-type crystal structure on the basis of an X-ray diffraction result. Therefore, the solid electrolyte may include other crystalline phases that are not detectable even at the lowest detection sensitivity level of X-ray diffraction.

In the case where M is Bi and the solid electrolyte according to the first embodiment is composed of a single phase of a cubic-system garnet-type crystal structure, the solid electrolyte exhibits a high density of 3.76 g/cm³ to 4.27 g/cm³, even when obtained by firing at a low temperature. The solid electrolyte also has high ionic conductivity, for example, comparable to the ionic conductivities of solid electrolytes having a conventional Pr-containing garnet-type crystal structure, and has an ionic conductivity of, for example, 1×10⁻⁴ S/cm or more at room temperature. As used herein, the term “room temperature” refers to 25° C. in one example. Furthermore, in the case where the solid electrolyte is composed of a single phase of a cubic-system garnet-type crystal structure, its properties do not change even over a long time of, for example, 500 hours. For example, the absolute value of the percentage change in the ionic conductivity after 500 hours may be 3% or less. Consequently, the solid electrolyte has excellent atmospheric stability. With the above configuration, for example, the solid electrolyte in the form of a sintered body having a high density (e.g., porosity of 3% to 10%) has high ionic conductivity and excellent atmospheric stability.

The solid electrolyte according to the first embodiment in which M is Bi may have a density of 2.18 g/cm³ or more and 4.27 g/cm³ or less, 3.37 g/cm³ or more and 4.2 g/cm³ or less, or 3.76 g/cm³ or more and 4.27 g/cm³ or less. In the case where the solid electrolyte has a density of 3.76 g/cm³ or more and 4.27 g/cm³ or less, the ionic conductivity is further improved. In one example, the solid electrolyte having a density of 3.76 g/cm³ or more and 4.27 g/cm³ or less can have a sintering temperature equal to or lower than the melting point of Ag and have an ionic conductivity of 3.3×10⁻⁵ S/cm or more at room temperature.

Next, a method for manufacturing the solid electrolyte according to the first embodiment is described.

The method for manufacturing the solid electrolyte includes: mixing raw materials including an oxide containing Li, an oxide containing Pr, an oxide containing Zr, and an oxide of M: obtaining a compact of a mixture resulting from the mixing; and sintering the compact. M is at least one selected from the group consisting of Sb, Bi, As, Ge, and Te.

The solid electrolyte according to the first embodiment can be manufactured, for example, by the following method.

Metal oxides are prepared as the raw materials, and then the masses of the raw materials are measured to have a targeted chemical composition.

For example, in the case where the targeted chemical composition is Li₇₍₁₊ₓ₁₎α1₃β1₂₊ₐ₁Sb_{y1}O_{12+3.5x1+1.5y1+b1}, Li₂CO₃ powder, Pr₆O₁₁ powder, ZrO₂ powder, and Sb₂O₃ powder are prepared as the raw materials, and then the masses of these raw materials are measured to have a molar ratio of Li:Pr:Zr:O:Sb=(7(1+x1):3:(2+a1):(12+3.5x1+1.5y1+b1):y1.

For example, in the case where the targeted chemical composition is Li₇₍₁₊ₓ₂₎α2₃β2₂₊ₐ₂Bi_{y2}O_{12+3.5x2+1.5y2+b2}, Li₂CO₃ powder, Pr₆O₁₁ powder, ZrO₂ powder, and Bi₂O₃ powder are prepared as the raw materials, and then the masses of these raw materials are measured to have a molar ratio of Li:Pr:Zr:O:Bi=(7(1+x2)):3:(2+a2):(12+3.5x2+1.5y2+b2):y2.

Subsequently, the raw materials are mixed and then ground to obtain a powder mixture. The resulting powder mixture is calcined. Next, the calcined powder is ground. Subsequently, an organic binder is mixed with the ground powder and then dispersed in the powder to obtain a mixture. A filter is then used to obtain a mixture of particles having a predetermined particle diameter. The mixture is pressured to obtain a compact having desired dimensions and thickness. Thus, the compact according to the first embodiment is obtained. The resulting compact is sintered to obtain a sintered body. Thus, the solid electrolyte according to the first embodiment is obtained. In other words, the solid electrolyte according to the first embodiment is in the form of a sintered body.

Sintering of the compact according to the first embodiment may be performed by firing at less than 1050° C. This enables the compact according to the first embodiment to be sintered together with a low-melting and high-electrical-conductivity metal such as Ag or a Ag—Pd alloy containing 80% or more Ag. It is also possible to perform the sintering together with a low-melting and high-electrical-conductivity conductor containing Au or Cu. The firing temperature may be 940° C. or more and 1040° C. or less, 940° C. or more and 1030° C. or less, or 940° C. or more and 1000° C. or less. The firing time is, for example, 1 hour or more and 10 hours or less. The ambient conditions during the firing may be the atmosphere, a neutral atmosphere (e.g., nitrogen atmosphere), or a reducing atmosphere (e.g., reducing gas atmosphere such as hydrogen). Accordingly, in the case where the solid electrolyte according to the first embodiment is used in, for example, an electricity storage device, a metal with high electrical conductivity and low contents of Pd and Pt, which are rare and expensive resources, can be used as electrodes. This can achieve an electricity storage device that has low resistance losses, is inexpensive, and does not include large amounts of rare resources.

As used herein, “sintering at a low temperature” means sintering at a temperature of, for example, less than 1050° C. This temperature may be 940° C. or more and less than 1050° C. or 940° C. or more and 1000° C. or less.

In place of the above manufacturing method, the following method can be used to manufacture the solid electrolyte according to the first embodiment.

First, an organic binder is mixed with the raw materials to obtain a slurry. The resulting slurry is used to form a green sheet. A plurality of the green sheets are stacked to obtain a stack. The stack is pressured to pressure-bond the plurality of green sheets. The pressure-bonded stack is then sintered. Thus, an appropriate manufacturing method can be selected according to the shape of the targeted solid electrolyte. In the manufacturing method described above, the metal oxide powders are mixed, calcined, and then sintered to obtain the solid electrolyte. Alternatively, the solid electrolyte according to the first embodiment may be obtained by: synthesizing in advance, as the precursor for the solid electrolyte, a Pr-based pyrochlore compound (e.g., Pr₂Zr₂O₇) formed through calcination; and using the precursor as the raw material.

The solid electrolyte according to the first embodiment is described in more detail below. The solid electrolyte according to the first embodiment may be described on the premise that the solid electrolyte according to the first embodiment includes a crystalline phase having a garnet-type crystal structure containing Pr. The garnet-type crystal structure containing Pr may hereinafter be referred to as a Pr-based garnet-type crystal structure.

There is a tendency that, when a Li-based material is sintered at a high firing temperature, the evaporation of Li causes segregation of a Li-deficient crystalline phase (e.g., pyrochlore phase in a garnet-type solid electrolyte containing La (namely, La₂Zr₂O₇)) at the grain boundaries. The segregated Li-deficient crystalline phase, even in a trace amount, is decomposed by reaction with at least one selected from the group consisting of moisture and carbon dioxide present in the atmosphere. This causes the segregated Li-deficient crystalline phase to expand. The expansion generates cracks between the crystal particles having a garnet-type crystal structure, and eventually, the sintered body collapses. On the other hand, since the solid electrolyte according to the first embodiment is formed by sintering the compact according to the first embodiment at a low temperature of, for example, less than 1050° C., Li does not evaporate and the solid electrolyte has a garnet-type crystal structure with low Li deficiency. Consequently, even with many pores contained, excellent atmospheric stability is still exhibited. Therefore, the solid electrolyte according to the first embodiment has excellent atmospheric stability and excellent thermal shock resistance.

By further containing M in the crystalline phase having a garnet-type crystal structure containing Pr in this manner, the compact according to the first embodiment is sintered at a low temperature of, for example, less than 1050° C. to obtain the solid electrolyte according to the first embodiment. Consequently, the evaporation of the components contained in the compact according to the first embodiment during sintering is suppressed, thereby improving atmospheric stability.

In particular, in the case where M includes Sb, the compact according to the first embodiment is sintered at a low temperature of, for example, less than 1050° C. to obtain the solid electrolyte according to the first embodiment. Consequently, the evaporation of the components contained in the compact according to the first embodiment during sintering is suppressed, thereby improving atmospheric stability even with low density. Therefore, even with a low density (i.e., many pores contained, e.g., porosity of 10% to 50%), the solid electrolyte according to the first embodiment exhibits a high ionic conductivity (e.g., 5.8×10⁻⁶ S/cm or more) and excellent reliability (e.g., atmospheric stability and thermal shock resistance).

In particular, in the case where M includes Bi, the compact according to the first embodiment is sintered at a low temperature of, for example, less than 1050° C. to obtain the solid electrolyte according to the first embodiment. Consequently, the evaporation of the components contained in the compact according to the first embodiment during sintering is suppressed, thereby improving atmospheric stability. Therefore, with a high density (i.e., pores reduced, e.g., porosity of 10% or less), the solid electrolyte according to the first embodiment exhibits a high ionic conductivity (e.g., 5.8×10⁻⁶ S/cm or more) and excellent reliability (e.g., atmospheric stability and plating resistance).

In fact, the present inventors have found that a Pr—Zr-based pyrochlore phase (e.g., Pr₂Zr₂O₇) has high atmospheric stability. In the case where the solid electrolyte according to the first embodiment has crystalline phases having a garnet-type crystal structure containing Pr, the solid electrolyte according to the first embodiment has high stability even with a trace amount of a Pr—Zr-based pyrochlore phase present between the crystalline phases.

In the first embodiment, since both Pr³⁺ ions and Pr⁴⁺ ions are incorporated into the crystal lattice of the solid electrolyte having a Pr-based garnet-type crystal structure, defects or interstitial ions are likely to be formed at low energy. Moreover, owing to the presence of the low-melting M oxide in the compact according to the first embodiment, the particle surfaces of the M oxide, wetted by the liquid phase, act as an accelerator for sintering and a solid-phase reaction. Consequently, a cubic-system garnet-type crystal structure is formed at low temperature. For example, owing to the presence of the low-melting Sb oxide in the compact according to the first embodiment, the particle surfaces of the Sb oxide, wetted by the liquid phase, act as an accelerator for sintering and a solid-phase reaction. In another example, owing to the presence of the low-melting Bi oxide in the compact according to the first embodiment, the particle surfaces of the Bi oxide, wetted by the liquid phase, act as an accelerator for sintering and a solid-phase reaction. Consequently, a cubic-system garnet-type crystal structure is formed at low temperature.

Both the Pr³⁺ ions and the Pr⁴⁺ ions contained in the garnet-type crystal structure form ion diffusion pathways. This is probably the reason why the solid electrolyte including a crystalline phase having a Pr-based garnet-type crystal structure has high ionic conductivity.

Through the above mechanism, the solid electrolyte according to the first embodiment including a crystalline phase having a Pr-based garnet-type crystal structure containing Sb, obtained by sintering the compact according to the first embodiment at a low temperature of less than 1050° C., has not only a high ionic conductivity (e.g., 5.8×10⁻⁶ S/cm or more at room temperature) but also high reliability (e.g., atmospheric stability and thermal shock resistance). In particular, in the case where the solid electrolyte according to the first embodiment containing Sb is composed of a single phase of a cubic-system garnet-type crystal structure and has a density of 2.7 g/cm³ or more and 4.2 g/cm³ or less, the solid electrolyte according to the first embodiment has a higher ionic conductivity (e.g., 1×10⁻⁴ S/cm or more at room temperature) and has durability and reliability in thermal cycling and the like over a long time. Additionally, the crystal phase of the pyrochlore phase generated by calcination can, upon further sintering, transition to a tetragonal system of the garnet-type crystal structure and then to a cubic-system of the garnet-type crystal structure. Along with the transition of the crystalline phase, the compact according to the first embodiment is sintered even at low temperature, resulting in a solid electrolyte having a density of 2.1 g/cm³ or more and 4.2 g/cm³ or less. Additionally, solid electrolytes having a conventional Pr-containing garnet-type crystal structure free of Sb have a density of 3.3 g/cm³ or more and 4.5 g/cm³ or less, and have a sintering temperature that is at least 100° C. higher than the sintering temperature for the solid electrolyte according to the first embodiment. Furthermore, through the above mechanism, the solid electrolyte according to the first embodiment including a crystalline phase having a Pr-based garnet-type crystal structure containing Bi, obtained by sintering the compact according to the first embodiment at a low temperature of less than 1050° C., has not only a high ionic conductivity (e.g., 5.8×10⁻⁶ S/cm or more at room temperature) but also high reliability (e.g., atmospheric stability and plating resistance). In particular, in the case where the solid electrolyte according to the first embodiment containing Bi is composed of a single phase of a cubic-system garnet-type crystal structure and has a density of 3.76 g/cm³ or more and 4.27 g/cm³ or less, the solid electrolyte according to the first embodiment has a higher ionic conductivity (e.g., 1×10⁻⁴ S/cm or more at room temperature) and has durability and reliability in plating resistance and the like over a long time. Additionally, the crystal phase of the pyrochlore phase generated by calcination can, upon further sintering, transition to a tetragonal system of the garnet-type crystal structure and then to a cubic-system of the garnet-type crystal structure. Along with the transition of the crystalline phase, the compact according to the first embodiment is sintered even at low temperature, resulting in a solid electrolyte having a density of 3.76 g/cm³ or more and 4.27 g/cm³ or less. Additionally, solid electrolytes having a conventional Pr-containing garnet-type crystal structure free of Bi require a sintering temperature that is at least 100° C. higher than the sintering temperature for the solid electrolyte according to the first embodiment in order to achieve a comparable density.

Moreover, in the first embodiment, in the case where the Li content is in excess of the stoichiometric composition ratio, that is, in the case where x1>0 in the composition formula (1) or x2>0 in the composition formula (2) is satisfied, sintering and changes in crystalline phase are more likely to progress from lower temperatures than in the case where x1=0 or x2=0 is satisfied. This stably forms a cubic-system garnet-type crystal structure and increases the ionic conductivity. Furthermore, in the case where x1≤0.35 in the composition formula (1) or x2≤0.35 in the composition formula (2) is satisfied, the Li content is not overly excessive, thus preventing a decrease in ionic conductivity caused by generation of unnecessary phases. Moreover, since the Li content is not overly excessive, a fusion issue of the solid electrolyte due to excessive sintering does not occur. In the case where x1≤0.3 in the composition formula (1) or x2≤0.3 in the composition formula (2) is satisfied, the occurrence of fusion of the solid electrolyte is more reliably suppressed than in the case where the value of x1 or the value of x2 exceeds 0.3.

As demonstrated in examples described later, in the composition formula (1), the value of x1 may be −0.05 or more and 0.35 or less. Compacts with low Li content are slightly inferior in terms of sintering properties, and accordingly require sintering at high temperature in some cases. From the viewpoint of decreasing the temperature at which the compact according to the first embodiment is sintered, the value of x1 may be, for example, 0 or more. To decrease the temperature at which the compact according to the first embodiment is sintered, the value of x1 may be 0 or more and 0.35 or less. From the viewpoints of further improving the ionic conductivity and suppressing the occurrence of fusion due to excessive sintering, the value of x1 may be 0 or more and 0.3 or less. From the viewpoints of further decreasing the sintering temperature of the compact according to the first embodiment, further improving the ionic conductivity, and suppressing the occurrence of fusion due to excessive sintering, the value of x1 may be more than 0 and 0.3 or less.

Furthermore, as demonstrated in the examples described later, in the composition formula (2), the value of x2 may be −0.05 or more and 0.35 or less. Compacts with low Li content are slightly inferior in terms of sintering properties, and accordingly require sintering at high temperature in some cases. From the viewpoint of decreasing the temperature at which the compact according to the first embodiment is sintered, the value of x2 may be, for example, 0 or more. To decrease the temperature at which the compact according to the first embodiment is sintered, the value of x2 may be 0 or more and 0.35 or less. From the viewpoints of further improving the ionic conductivity and suppressing the occurrence of fusion due to excessive sintering, the value of x2 may be 0 or more and 0.3 or less. From the viewpoints of further decreasing the sintering temperature of the compact according to the first embodiment, further improving the ionic conductivity, and suppressing the occurrence of fusion due to excessive sintering, the value of x2 may be more than 0 and 0.3 or less.

Upon Li evaporation during sintering at high temperature, a Li deficiency can occur on the free surface of the solid electrolyte containing Li. The term “free surface” refers to the surface that has not been processed after sintering. On the free surface of the sintered body, a crystalline phase resulting from excessive sintering can also be formed.

For example, in the case where the solid electrolyte is disc-shaped, the front surface of the solid electrolyte is composed of a crystalline phase having a cubic-system garnet-type crystal structure and a Li-deficient pyrochlore phase, while the back surface of the solid electrolyte is composed of a single phase of the cubic-system garnet-type crystal structure. X-ray diffraction is effective for analyzing the crystalline phase on the surface of the solid electrolyte. With X-ray diffraction, a portion of the crystalline phase having a thickness of approximately 20 micrometers from the surface of the solid electrolyte can be analyzed. The results of the analysis of the surface crystalline phase are used as a reference for designing the synthesis process.

As demonstrated in Examples 4, 5, 7 to 9, 12, 13, 15, 16, 19 to 22, 26, 27, 30, 31, 42, 43, 45 to 47, 50, 51, 53, 54, 57 to 60, 64, 65, 68, and 69 described later, the solid electrolyte according to the first embodiment may be composed of a crystalline phase having a cubic-system garnet-type crystal structure. In the first embodiment, not only the surface of the solid electrolyte but also the interior of the solid electrolyte can be formed from a single phase. In the case where the solid electrolyte according to the first embodiment is composed of a single phase of a cubic-system garnet-type crystal structure, not only low density and high ionic conductivity but also excellent reliability is achieved. This is because the internal stress arising from expansion caused by moisture or carbon dioxide present in the atmosphere is not inherent in the solid electrolyte.

In the case where the free surface has Li deficiency, for example, the surface layer of the solid electrolyte may be removed by barrel polishing to obtain a solid electrolyte composed of a desired crystalline phase (e.g., crystalline phase having a cubic-system garnet-type crystal structure). In the case where the free surface includes a crystalline phase resulting from excessive sintering, the surface layer can also be removed in the same manner as above.

In industrial mounting processes, a white sintered body that is slightly discolored can be considered as defective. Even in the case where a white-based sintered body is not considered as defective, slight discoloration of such a sintered body is undesirable taking into consideration the contrast in image recognition.

For this reason, in industrial mounting processes, an additive can be incorporated into a solid electrolyte to intentionally darken the color of the solid electrolyte. However, such an additive can cause an issue of degradation in the properties of the solid electrolyte. The solid electrolyte according to the first embodiment exhibits a black hue derived from Pr. Consequently, no additive is required for the solid electrolyte according to the first embodiment. Therefore, in the first embodiment, it is possible to prevent the issue of property degradation of the solid electrolyte caused by incorporation of additives.

### Second Embodiment

A second embodiment is described below. The matters described in the first embodiment are omitted as appropriate.

An electricity storage device according to the second embodiment includes a first electrode, a second electrode, and the solid electrolyte according to the first embodiment.

The electricity storage device according to the second embodiment uses the solid electrolyte described in the first embodiment. The electricity storage device according to the second embodiment has excellent performance and high stability. The electricity storage device according to the second embodiment is, for example, a battery, a multilayer capacitor, or an electric double-layer capacitor. The electricity storage device according to the second embodiment is, for example, a battery or a multilayer capacitor.

As described above, the electricity storage device according to the second embodiment includes the solid electrolyte according to the first embodiment. As described in the first embodiment, the compact according to the first embodiment is sintered at a temperature of less than 1050° C. Therefore, in the electricity storage device according to the second embodiment, at least one selected from the group consisting of the first electrode and the second electrode may include a metal having a low melting point. For example, at least one selected from the group consisting of the first electrode and the second electrode may include a metal having a melting point of less than 1050° C. At least one selected from the group consisting of the first electrode and the second electrode may include a metal having a melting point higher than the sintering temperature of the compact according to the first embodiment. At least one selected from the group consisting of the first electrode and the second electrode may include a metal having a melting point higher than the sintering temperature of the compact according to the first embodiment and is less than 1050° C. The first electrode and the second electrode each may include a metal having a melting point of less than 1050° C. The first electrode and the second electrode each may include a metal having a melting point higher than the sintering temperature of the compact according to the first embodiment. The first electrode and the second electrode each may include a metal having a melting point higher than the sintering temperature of the compact according to the first embodiment and is less than 1050° C. This broadens the range of selection for electrode materials, enabling the first electrode and the second electrode to be formed from, for example, a highly electrically conductive metal with high Ag content or an inexpensive metal with low Pd and Pt contents.

In one example, at least one selected from the group consisting of the first electrode and the second electrode may include a Ag—Pd alloy. The first electrode and the second electrode each may include a Ag—Pd alloy. At least one selected from the group consisting of the first electrode and the second electrode may be composed of a Ag—Pd alloy. The molar ratio of Ag to Pd in the Ag—Pd alloy may be more than 80/20. The molar ratio of Ag to Pd is hereinafter referred to as “a Ag/Pd molar ratio”. A Ag—Pd alloy having a Ag/Pd molar ratio of more than 80/20 has a melting point of approximately 1050° C. The first electrode and the second electrode each may be composed of a Ag—Pd alloy. Since the Ag end-member region of a Ag—Pd alloy has low electrical resistance, using a Ag—Pd alloy with a Ag/Pd molar ratio of more than 80/20 for the first electrode and the second electrode achieves an electricity storage device having excellent performance at low cost. The Ag/Pd molar ratio may be less than 100/0.

At least one selected from the group consisting of the first electrode and the second electrode may be composed of Ag. The first electrode and the second electrode may be composed of Ag.

The compact according to the first embodiment can be co-sintered with the first electrode and the second electrode that are composed of Ag to obtain an electricity storage device including the first electrode, the second electrode, and the solid electrolyte. The electricity storage device has sufficient electrical conductivity and excellent atmospheric stability.

In the case where the electricity storage device according to the second embodiment is a battery, the battery includes the first electrode, the second electrode, and an electrolyte layer provided between the first electrode and the second electrode. At least one selected from the group consisting of the first electrode, the second electrode, and the electrolyte layer includes the solid electrolyte according to the first embodiment. The electrolyte layer may include the solid electrolyte according to the first embodiment. Thus, a battery having excellent performance and excellent stability is provided.

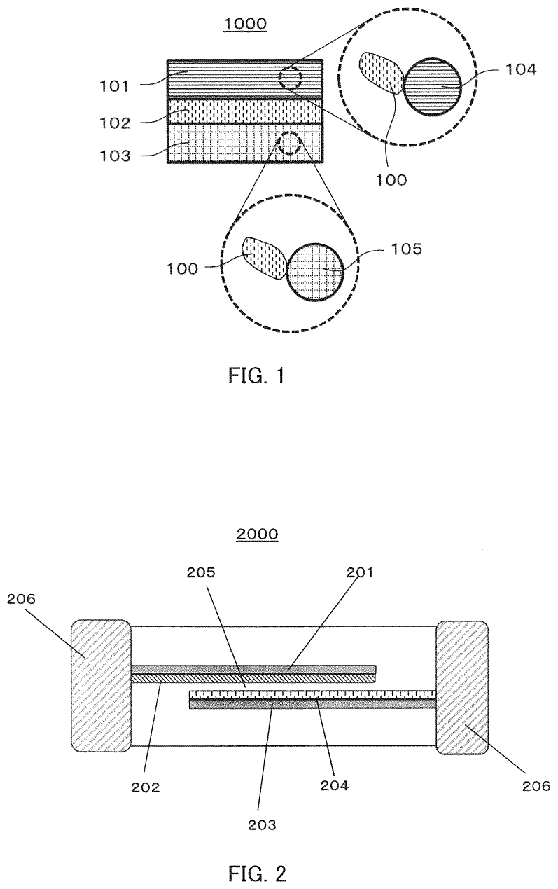

FIG. 1 is a cross-sectional view of a battery 1000 according to the second embodiment. As shown in FIG. 1, the battery 1000 according to the second embodiment includes a positive electrode 101, a negative electrode 103, and an electrolyte layer 102. The positive electrode 101 and the negative electrode 103 respectively correspond to the first electrode and the second electrode of the electricity storage device according to the second embodiment. The positive electrode 101 includes positive electrode active material particles 104 and a solid electrolyte 100 (i.e., the solid electrolyte according to the first embodiment). The electrolyte layer 102 is disposed between the positive electrode 101 and the negative electrode 103. The electrolyte layer 102 is in contact with both the positive electrode 101 and the negative electrode 103. The electrolyte layer 102 may include the solid electrolyte according to the first embodiment. The negative electrode 103 includes negative electrode active material particles 105 and the solid electrolyte 100 (i.e., the solid electrolyte according to the first embodiment). The battery 1000 is, for example, an all-solid-state lithium secondary battery. The battery 1000 according to the second embodiment has excellent performance and excellent stability, owing to the inclusion of the solid electrolyte according to the first embodiment.

In the second embodiment, all of the positive electrode 101, the negative electrode 103, and the electrolyte layer 102 may include the solid electrolyte according to the first embodiment. The electrolyte layer 102 may include the solid electrolyte according to the first embodiment. Since the electrolyte layer 102 includes the largest amount of electrolyte material among the positive electrode 101, the negative electrode 103, and the electrolyte layer 102, using the solid electrolyte according to the first embodiment in the electrolyte layer 102 improves performance and stability. As long as at least one selected from the group consisting of the positive electrode 101, the negative electrode 103, and the electrolyte layer 102 includes the solid electrolyte according to the first embodiment, the battery 1000 has excellent performance and excellent stability. The positive electrode 101, the negative electrode 103, and the electrolyte layer 102 each may include a solid electrolyte other than the solid electrolyte according to the first embodiment.

The positive electrode 101 includes a positive electrode active material, that is, a material capable of occluding and releasing metal ions. An example of the metal ions is a lithium ion. The positive electrode 101 includes, for example, a positive electrode active material (e.g., the positive electrode active material particles 104). The positive electrode 101 may include the solid electrolyte 100.

Examples of the positive electrode active material include a lithium-containing transition metal oxide, a lithium-free transition metal oxide, a transition metal fluoride, a polyanion material, a fluorinated polyanion material, a transition metal sulfide, a transition metal oxyfluoride, a transition metal oxysulfide, and a transition metal oxynitride. Using a lithium-containing transition metal oxide as the positive electrode active material can reduce the manufacturing cost of the battery 1000 and can increase the average discharge voltage of the battery 1000. As the positive electrode active material, at least one selected from the group consisting of Li(NiCoAl)O₂ and LiCoO₂ may be contained in the positive electrode 101. These transition metal oxides can be used to increase the energy density of the battery 1000.

The positive electrode active material particles 104 may have a median diameter of 0.1 micrometers or more and 100 micrometers or less. In the case where the positive electrode active material particles 104 have an appropriate size, the positive electrode active material particles 104 and the particles of the solid electrolyte 100 are well dispersed in the positive electrode 101. Consequently, the battery 1000 has excellent discharge characteristics. Furthermore, lithium ions can rapidly diffuse within the positive electrode active material particles 104, and consequently the battery 1000 has high output. To achieve good dispersion of the positive electrode active material particles 104 and the particles of the solid electrolyte 100, the positive electrode active material particles 104 may have a larger median diameter than the particles of the solid electrolyte 100.

The median diameter refers to the particle diameter (d50) at which the cumulative volume equals 50% in a particle size distribution. The median diameter is determined from a volume-based particle size distribution measured using a laser diffraction scattering particle size analyzer.

In the positive electrode 101, the percentage of a volume vc1 of the positive electrode active material particles 104 in the sum of the volume vc1 of the positive electrode active material particles 104 and a volume vc2 of the solid electrolyte 100 is, for example, 30% or more and 95% or less. In other words, the volume ratio expressed by the mathematical expression (vc1/(vc1+vc2)) may be 0.3 or more and 0.95 or less. The percentage of the volume vc2 of the solid electrolyte 100 in the sum of the volume vc1 of the positive electrode active material particles 104 and the volume vc2 of the solid electrolyte 100 is, for example, 5% or more and 70% or less. In other words, the volume ratio expressed by the mathematical expression (vc2/(vc1+vc2)) may be 0.05 or more and 0.70 or less. Appropriately adjusting the amount of the positive electrode active material particles 104 and the amount of the solid electrolyte 100 ensures sufficient energy density of the battery 1000, enabling the battery 1000 to operate at high output.

The positive electrode 101 may have a thickness of 10 micrometers or more and 500 micrometers or less. Appropriately adjusting the thickness of the positive electrode 101 ensures sufficient energy density of the battery 1000, enabling the battery 1000 to operate at high output.

As described above, the electrolyte layer 102 may include the solid electrolyte according to the first embodiment. The electrolyte layer 102 may include not only the solid electrolyte according to the first embodiment but also a solid electrolyte other than the solid electrolyte according to the first embodiment.

The solid electrolyte according to the first embodiment is hereinafter referred to as a first solid electrolyte. The solid electrolyte other than the solid electrolyte according to the first embodiment is referred to as a second solid electrolyte.

In the case where the electrolyte layer 102 includes not only the first solid electrolyte but also the second solid electrolyte, the first solid electrolyte and the second solid electrolyte may be uniformly dispersed in the electrolyte layer 102. The second solid electrolyte may have a different composition from the composition of the first solid electrolyte. The second solid electrolyte may have a different structure from the composition of the first solid electrolyte.

The electrolyte layer 102 may have a thickness of 1 micrometer or more and 500 micrometers or less. Appropriately adjusting the thickness of the electrolyte layer 102 can reliably prevent short circuit between the positive electrode 101 and the negative electrode 103 and enable the battery 1000 to operate at high output.

The negative electrode 103 includes a negative electrode active material, that is, a material capable of occluding and releasing metal ions. An example of the metal ions is a lithium ion. The negative electrode 103 includes, for example, a negative electrode active material (e.g., the negative electrode active material particles 105). The negative electrode 103 may include the solid electrolyte 100.

Examples of the negative electrode active material include a metal material, a carbon material, an oxide, a nitride, a tin compound, and a silicon compound. The metal material may be a simple substance of metal or an alloy. Examples of the metal material include lithium metal and a lithium alloy. Examples of the carbon material include natural graphite, coke, partially graphitized carbon, carbon fiber, spherical carbon, artificial graphite, and amorphous carbon. From the viewpoint of capacity density, at least one selected from the group consisting of silicon (i.e., Si), tin (i.e., Sn), a silicon compound, and a tin compound can be suitably used as the negative electrode active material.

The negative electrode active material particles 105 may have a median diameter of 0.1 micrometers or more and 100 micrometers or less. In the case where the negative electrode active material particles 105 have an appropriate size, the negative electrode active material particles 105 and the solid electrolyte 100 are well dispersed. Consequently, the battery 1000 has excellent discharge characteristics. Furthermore, lithium ions can rapidly diffuse within the negative electrode active material particles 105, and consequently the battery 1000 has high output. To achieve good dispersion of the negative electrode active material particles 105 and the solid electrolyte 100, the negative electrode active material particles 105 may have a larger median diameter than the particles of the solid electrolyte 100.

In the negative electrode 103, the percentage of a volume va1 of the negative electrode active material particles 105 in the sum of the volume va1 of the negative electrode active material particles 105 and a volume va2 of the solid electrolyte 100 is, for example, 30% or more and 95% or less. In other words, the volume ratio expressed by the mathematical expression (va1/(va1+va2)) may be 0.3 or more and 0.95 or less. The percentage of the volume va2 of the solid electrolyte 100 in the sum of the volume va1 of the negative electrode active material particles 105 and the volume va2 of the solid electrolyte 100 is, for example, 5% or more and 70% or less. In other words, the volume ratio expressed by the mathematical expression (va2/(va1+va2)) may be 0.05 or more and 0.70 or less. Appropriately adjusting the amount of the negative electrode active material particles 105 and the amount of the solid electrolyte 100 ensures sufficient energy density of the battery 1000, enabling the battery 1000 to operate at high output.

The negative electrode 103 may have a thickness of 10 micrometers or more and 500 micrometers or less. Appropriately adjusting the thickness of the negative electrode 103 ensures sufficient energy density of the battery 1000, enabling the battery 1000 to operate at high output.

At least one selected from the group consisting of the positive electrode 101, the electrolyte layer 102, and the negative electrode 103 may include the second solid electrolyte.

The second solid electrolyte may be a sulfide solid electrolyte. The sulfide solid electrolyte can be included in the positive electrode 101, the negative electrode 103, and the electrolyte layer 102. Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂. To the sulfide solid electrolyte, LiX (X is F, Cl, Br, or I), Li₂O, MO_{q}, or LiₚMO_{q} (M is P, Si, Ge, B, Al, Ga, In, Fe, or Zn, p is a natural number, and q is a natural number) may be added. The sulfide solid electrolyte improves the ionic conductivity of the positive electrode 101, the electrolyte layer 102, and the negative electrode 103.

The second solid electrolyte may be an oxide solid electrolyte. The oxide solid electrolyte can be included in the positive electrode 101, the negative electrode 103, and the electrolyte layer 102. The oxide solid electrolyte improves the ionic conductivity of the positive electrode 101, the electrolyte layer 102, and the negative electrode 103.

Examples of the oxide solid electrolyte include:
(i) a NASICON-type solid electrolyte, such as LiTi₂(PO₄)₃ or its element-substituted substance;
(ii) a (LaLi)TiO₃-type perovskite solid electrolyte;
(iii) a LISICON-type solid electrolyte, such as Li₁₄ZnGe₄O₁₆, Li₄SiO₄, LiGeO₄, or its element-substituted substance;
(iv) a garnet-type solid electrolyte, such as Li₇La₃Zr₂O₁₂ or its element-substituted substance;
(v) Li₃N and its N-substituted substance; and
(vi) Li₃PO₄ and its N-substituted substance.

The second solid electrolyte may be a halide solid electrolyte. The halide solid electrolyte can be included in the positive electrode 101, the negative electrode 103, and the electrolyte layer 102. The halide solid electrolyte improves the ionic conductivity.

Examples of the halide solid electrolyte include Li₃InBr₆, Li₃InCl₆, Li₂FeCl₄, Li₂CrCl₄, and LisOCl.

The second solid electrolyte may be a complex hydride solid electrolyte. The complex hydride solid electrolyte can be included in the positive electrode 101, the negative electrode 103, and the electrolyte layer 102. The complex hydride solid electrolyte improves the ionic conductivity. Examples of the complex hydride solid electrolyte include LiBH₄—LiI and LiBH₄—P₂S₅.

The second solid electrolyte may be an organic polymer solid electrolyte. The organic polymer solid electrolyte can be included in the positive electrode 101, the negative electrode 103, and the electrolyte layer 102. The organic polymer solid electrolyte improves the ionic conductivity of the solid electrolyte 100. An example of the organic polymer solid electrolyte is a compound of a polymer compound and a lithium salt. The polymer compound may have an ethylene oxide structure. The polymer compound having an ethylene oxide structure can contain a lithium salt in a large amount, and accordingly can further increase the ionic conductivity. Examples of the lithium salt include LiPF₆, LiBF₄, LiSbF₆, LiAsF₆, LISO₃CF₃, LIN(SO₂CF₃)₂, LIN(SO₂C₂F₅)₂, LIN(SO₂CF₃)(SO₂C₄F₉), and LiC(SO₂CF₃)₃. One lithium salt selected from the above may be used alone. Alternatively, a mixture of two or more lithium salts selected from the above may be used.

At least one selected from the group consisting of the positive electrode 101, the negative electrode 103, and the electrolyte layer 102 may contain a nonaqueous electrolyte solution, a gel electrolyte, or an ionic liquid for the purpose of facilitating the transfer of lithium ions and improve the output characteristics of the battery 1000.

The nonaqueous electrolyte solution contains a nonaqueous solvent and a lithium salt dissolved in the nonaqueous solvent.

Examples of the nonaqueous solvent include a cyclic carbonate solvent, a chain carbonate solvent, a cyclic ether solvent, a chain ether solvent, a cyclic ester solvent, a chain ester solvent, and a fluorinated solvent. Examples of the cyclic carbonate solvent include ethylene carbonate, propylene carbonate, and butylene carbonate. Examples of the chain carbonate solvent include dimethyl carbonate, ethyl methyl carbonate, and diethyl carbonate. Examples of the cyclic ether solvent include tetrahydrofuran, 1,4-dioxane, and 1,3-dioxolane. Examples of the chain ether solvent include 1,2-dimethoxyethane and 1,2-diethoxyethane. Examples of the cyclic ester solvent include y-butyrolactone. Examples of the chain ester solvent include methyl acetate. Examples of the fluorinated solvent include fluoroethylene carbonate, methyl fluoropropionate, fluorobenzene, fluoroethylmethyl carbonate, and fluorodimethylene carbonate. As the nonaqueous solvent, one nonaqueous solvent selected from the group consisting of the above solvents may be used alone. Alternatively, a mixture of two or more nonaqueous solvents selected from the group consisting of the above solvents may be used.

Examples of the lithium salt include LiPF₆, LiBF₄, LiSbF₆, LiAsF₆, LiSO₃CF₃, LIN(SO₂CF₃)₂, LIN(SO₂C₂F₅)₂, LIN(SO₂CF₃)(SO₂C₄F₉), and LiC(SO₂CF₃)₃. One lithium salt selected from the above lithium salts may be used alone. Alternatively, a mixture of two or more lithium salts selected from the above may be used. The lithium salt may have a concentration of 0.5 mol/L or more and 2 mol/L or less.

An example of the gel electrolyte is a polymer material impregnated with a nonaqueous electrolyte solution. Examples of the polymer material include polyethylene oxide, polyacrylonitrile, polyvinylidene fluoride, and polymethyl methacrylate. Another example of the polymer material is a polymer having an ethylene oxide bond.

Examples of cations contained in the ionic liquid include:
(i) a cation of an aliphatic chain quaternary ammonium salt, such as tetraalkylammonium;
(ii) a cation of an aliphatic chain quaternary phosphonium salt, such as tetraalkylphosphonium;
(iii) an aliphatic cyclic ammonium, such as pyrrolidinium, morpholinium, imidazolinium, tetrahydropyrimidinium, piperazinium, or piperidinium; and
(iv) a nitrogen-containing heterocyclic aromatic cation, such as pyridinium or imidazolium. Examples of anions constituting the ionic liquid include PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, and C(SO₂CF₃)₃⁻. The ionic liquid may contain a lithium salt.

At least one selected from the group consisting of the positive electrode 101, the negative electrode 103, and the electrolyte layer 102 may contain a binder for the purpose of improving the adhesion between the particles. Examples of the binder include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethylcellulose. The binder can also be a copolymer. Examples of such a binder include a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. The binder may be a mixture of two or more materials selected from the above materials.

At least one selected from the group consisting of the positive electrode 101 and the negative electrode 103 may contain a conductive additive for the purpose of increasing the electronic conductivity.

Examples of the conductive additive include:
(i) graphite, such as natural graphite or artificial graphite;
(ii) carbon black, such as acetylene black or Ketjenblack;
(iii) a conductive fiber, such as a carbon fiber or a metal fiber;
(iv) fluorinated carbon;
(v) a metal powder, such as aluminum powder;
(vi) a conductive whisker, such as a zinc oxide whisker or a potassium titanate whisker;
(vii) a conductive metal oxide, such as titanium oxide; and
(viii) a conductive polymer compound, such as a polyaniline compound, a polypyrrole compound, or a polythiophene compound.

The conductive additive may have any shape. Examples of the shape of the conductive additive include an acicular shape, a flaky shape, a spherical shape, and an ellipsoidal shape. The conductive additive may be particulate.

The positive electrode active material particles 104 and the negative electrode active material particles 105 each may be coated with a coating material for the purpose of reducing interfacial resistance. Only a portion of the surface of each of the positive electrode active material particles 104 may be coated with the coating material.

Alternatively, the entire surface of each of the positive electrode active material particles 104 may be coated with the coating material. Similarly, only a portion of the surface of each of the negative electrode active material particles 105 may be coated with the coating material. Alternatively, the entire surface of each of the negative electrode active material particles 105 may be coated with the coating material. An example of the coating material is a solid electrolyte, such as a sulfide solid electrolyte, an oxide solid electrolyte, a halide solid electrolyte, an organic polymer solid electrolyte, or a complex hydride solid electrolyte. The coating material may be an oxide solid electrolyte. Oxide solid electrolytes have excellent high-potential stability. Using an oxide solid electrolyte as the coating material can improve the charge and discharge efficiency of the battery 1000.

Examples of oxide solid electrolytes that can be used as the coating materials include:
(i) a Li—Nb—O compound, such as LiNbO₃;
(ii) a Li—B—O compound, such as LiBO₂ or LisBO₃;
(iii) a Li—Al—O compound, such as LiAlO₂;
(iv) a Li—Si—O compound, such as Li₄SiO₄;
(v) Li₂SO₄;
(vi) a Li—Ti—O compound, such as Li₄Ti₅O₁₂;
(vii) a Li—Zr—O compound, such as Li₂ZrO₃;
(viii) a Li—Mo—O compound, such as Li₂MoO₃;
(ix) a Li-V-O compound, such as LiV₂O₅; and
(x) a Li—W—O compound, such as Li₂WO₄.

FIG. 2 is a cross-sectional view of a battery 2000 according to a modification of the second embodiment. As shown in FIG. 2, the battery 2000 includes a first internal electrode 201, a first active material layer 202, a second internal electrode 203, a second active material layer 204, an electrolyte layer 205, and external electrodes 206. The first internal electrode 201 and the second internal electrode 203 respectively correspond to the first electrode and the second electrode of the electricity storage device according to the second embodiment. The first internal electrode 201 and the second internal electrode 203 serve as the current collectors. The first active material layer 202 is disposed on the first internal electrode 201. The second active material layer 204 is disposed on the second internal electrode 203. The electrolyte layer 205 is provided between the first active material layer 202 and the second active material layer 204 that are disposed opposite each other.

The first active material layer 202 and the second active material layer 204 may be respectively a positive electrode active material layer and a negative electrode active material layer. In the case where the first active material layer 202 and the second active material layer 204 are respectively a positive electrode active material layer and a negative electrode active material layer, the first active material layer 202 includes a positive electrode active material and the second active material layer 204 includes a negative electrode active material. The positive electrode active material included in the first active material layer 202 is the same as the positive electrode active material described for the battery 1000. The negative electrode active material included in the second active material layer 204 is the same as the negative electrode active material described for the battery 1000.

The electrolyte layer 205 may include the solid electrolyte according to the first embodiment.

Next, a method for manufacturing the battery 2000 is described in detail.

First, the electrolyte layer 205 is produced. The electrolyte layer 205 can be produced by the method for manufacturing the solid electrolyte described in the first embodiment. The mass of a calcined and ground raw material powder is measured. To the calcined and ground raw material powder, an organic binder (e.g., butyral resin), a solvent (e.g., butyl acetate), and a plasticizer (e.g., butyl benzyl phthalate (BBP)) are added to obtain a mixture. These are dispersed within the mixture to obtain a slurry. The slurry is applied onto a film (e.g., polyethylene terephthalate film) by doctor blading to obtain green sheets. Next, a first active material paste is applied onto one green sheet by screen printing to form a positive electrode active material layer. The first internal electrode is formed on the positive electrode active material layer by printing. Thus, the green sheet with the first internal electrode on its surface is obtained. Similarly, a second active material paste is applied onto another green sheet by screen printing to form a negative electrode active material layer. The second internal electrode is formed on the negative electrode active material layer by printing. Thus, the green sheet with the second internal electrode on its surface is obtained.

The green sheet with the first internal electrode on its surface is stacked on the green sheet with the second internal electrode on its surface to obtain a stack. The stack is then pressured. The pressured stack is cut into multiple raw chip elements. The raw chip elements are heated, for example, in a nitrogen flow at a temperature of approximately 400° C. to approximately 500° C. to remove the organic binder. Thus, chip elements are obtained. Finally, the chip elements are sintered at a temperature of 940° C. or more and 1030° C. or less to obtain elements including the solid electrolyte according to the first embodiment. The elements thus obtained are each in the shape of a rectangular parallelepiped.

The external electrodes 206 are formed on a pair of opposite side surfaces of the rectangular parallelepiped element to obtain the battery 2000. The external electrodes 206 are formed, for example, as follows.

A paste including electrically conductive particles containing 0.5 mass % or more and 10 mass % or less of glass frit is applied onto a pair of opposite side surfaces of the element and dried. The paste is then heated in the atmosphere at a temperature of 500° C. or more and 850° C. or less to form the external electrodes 206. The glass frit has a softening point lower than the temperature at which the paste is heated. Solder may be used to form the external electrodes 206 on the pair of opposite side surfaces. In the case where solder is used, Ni—Sn plating, which is commonly used in the technical field of chip components, may be applied to the external electrodes 206. In the case where the first internal electrode 201 and the second internal electrode 203 are each formed from a metal that does not oxidize in the atmosphere, the paste applied to form the external electrodes 206 may be fired in the atmosphere. An example of the metal that does not oxidize in the atmosphere is a Ag—Pd alloy. In the case where the first internal electrode 201 and the second internal electrode 203 are each formed from a metal that oxidizes in the atmosphere, the paste applied to form the external electrodes 206 may be fired in an inert atmosphere, such as a nitrogen atmosphere. An example of the metal that oxidizes in the atmosphere is Ni or Cu.

Similar to the battery 1000, the battery 2000 also includes the solid electrolyte according to the first embodiment, and consequently has excellent performance and also exhibits excellent stability. In place of the sintering process described above, a known powder pressing process may be used to produce the battery 2000.

In the case where the electricity storage device according to the second embodiment is a multilayer capacitor, the multilayer capacitor includes the first internal electrode 201, the second internal electrode 203, the electrolyte layer 205, and the external electrodes 206. The multilayer capacitor neither includes the first active material layer 202 nor the second active material layer 204.

### Examples

The present disclosure is described in more detail below with reference to examples. Additionally, in the present examples, solid electrolytes containing Sb as M were evaluated in Sample Numbers 1 to 38, while solid electrolytes containing Bi as M were evaluated in Sample Numbers 39 to 76.

### Sample Numbers 1 to 38

### <Method for Producing Solid Electrolyte Evaluation Sample>

Solid electrolyte evaluation samples with the chemical compositions shown in Table 1A were each produced by the following method.

### Sample Numbers 1 to 32

First, Li₂CO₃ powder, Pr₆O₁₁ powder, ZrO₂ powder, and Sb₂O₃ powder were prepared as the raw materials. Subsequently, the mass of the raw materials was measured to obtain the chemical composition of the solid electrolyte shown in Table 1A.

Next, these powders were placed in a polyethylene ball mill. Stabilized zirconia balls and pure water were added to the ball mill to obtain a mixture. The balls had a diameter of 5 millimeters. The mixture was ground for approximately 20 hours. The ground raw material had an average particle diameter of 0.61 micrometers.

Subsequently, the ground mixture was dehydrated and then dried to obtain a powder.

The dried powder was placed in a high-purity alumina crucible and then the crucible was covered with a lid. The dried powder was calcined at approximately 750° C. for 2 hours.

Subsequently, the calcined powder was placed in a polyethylene ball mill. Stabilized zirconia balls and pure water were added to the ball mill to obtain a mixture. The balls had a diameter of 5 millimeters. The mixture was ground for approximately 20 hours. The ground powder had an average particle diameter of 0.89 micrometers.

Subsequently, the ground mixture was thoroughly dehydrated and then dried to obtain a powder.

Next, polyvinyl alcohol was added to the dried powder and mixed to obtain a mixture. The polyvinyl alcohol served as an organic binder. The powder was dispersed within the mixture, and then the mixture was classified through a filter with a square mesh having a spacing of 0.50 millimeters to obtain particles that passed through the filter. Subsequently, the particles were dried to remove moisture contained in the particles. The powder was then pressured at a pressure of 2 t/cm² using a die and a uniaxial hydraulic press to obtain a compact. The compact had the shape of a disc with a diameter of 13 millimeters and a thickness of 1.3 millimeters.

The compact was placed in a heat-resistant alumina container and sintered. Before the compact was placed in the container, zirconia powder was uniformly spread on the bottom of the container to prevent direct contact between the compact and the bottom of the container. The zirconia powder had an average particle size of 50 micrometers. Furthermore, a calcined powder having the same composition as the compact to be sintered was spread on the zirconia powder, and then the compact was placed on the calcined powder spread. The calcined powder is further supplied to the container and surrounded the compact such that the compact would be embedded in the calcined powder. The interior of the container was then heated to 450° C. to remove the organic binder (namely, polyvinyl alcohol). After this, a lid polished smoothly with #800 sandpaper was put onto the container to seal the container. The compact was then sintered at the firing temperature and firing time shown in Table 1A to obtain a solid electrolyte. Additionally, a preliminary test was performed to set the firing temperature for each of the samples. In this test, the temperature range, at which the shrinkage rate of the compact having the composition of the sample had reached its maximum value during its temperature increase, was identified to determine the sintering temperature of the sample.

On each of the upper and lower surfaces of the solid electrolyte, an electrode having the shape of a circle with a diameter of 6 millimeters (i.e., circle with an area of approximately 28.26 square millimeters per surface) was formed by Au deposition. Thus, the solid electrolyte evaluation samples in the examples were obtained.

### Sample Numbers 33 to 38

The raw materials used were Li₂CO₃ powder, La₂O₃ powder, ZrO₂ powder, and Sb₂O₃ powder. Except for this, the same procedure as for Sample Numbers 1 to 32 was performed to obtain the solid electrolyte evaluation samples of Sample Numbers 33 to 38.

The average particle diameter of the raw materials is represented by the value of the median diameter D50 determined from a volume-based particle size distribution measured using a laser diffraction scattering particle size analyzer. Specifically, the sample powder was dispersed in a 0.01 wt % Na hexametaphosphate aqueous solution using a homogenizer. The particle size distribution of the sample powder was then measured using a laser diffraction scattering particle size analyzer (manufactured by MicrotracBEL Corp., trade name: MT3100II). The value of D50 (i.e., cumulative 50% particle diameter) in the measured particle size distribution was considered as the average particle diameter. The average particle diameter of the calcined powder is also represented by the value of D50 thereof.

### <Evaluation of Solid Electrolyte>

The ionic conductivity of each of the solid electrolyte samples was measured as follows. Furthermore, the density of the solid electrolyte was calculated. Moreover, the crystalline phase of the solid electrolyte was identified. The solid electrolyte samples of Sample Numbers 2, 13, 33, and 37 were further evaluated for atmospheric stability.

### (Ionic Conductivity)

The ionic conductivity of the solid electrolyte was calculated from the impedance characteristics, thickness, and electrode area (namely, approximately 28.26 square millimeters) of the solid electrolyte. The impedance characteristics of the solid electrolyte were measured using an impedance measurement system (manufactured by Solartron Analytical Ltd., trade name: 12608W) in a thermostatic chamber maintained at 24° C. to 26° C., within a measurement frequency range of 10 Hz to 10 MHz.

### (Density)

The density (sintered density) of the solid electrolyte was calculated by dividing the mass of the solid electrolyte by the volume determined from the overall dimensions of the solid electrolyte.

### (Identification of Crystalline Phase)

The crystalline phase of the solid electrolyte was identified on the basis of both the analysis result of the crystalline phase of the interior of the solid electrolyte and the analysis result of the crystalline phase of the entire surface of the solid electrolyte.

The crystalline phase of the interior of the solid electrolyte was identified as follows. First, the solid electrolyte was finely ground in an agate mortar. The ground solid electrolyte was then subjected to X-ray diffraction analysis with an X-ray diffractometer (manufactured by Rigaku Corporation) using CuKα radiation to obtain an X-ray diffraction pattern at room temperature. On the basis of the analysis result of the X-ray diffraction pattern, the crystalline phase of the interior of the solid electrolyte was identified.

The crystalline phase of the entire surface of the solid electrolyte was identified as follows. The X-ray diffraction pattern of the free surface (i.e., the surface that had not been processed after sintering) of the solid electrolyte was obtained in the same manner as for the analysis of the crystalline phase of the interior of the solid electrolyte. Then, on the basis of the analysis result of the X-ray diffraction pattern, the crystalline phase of the entire surface of the solid electrolyte was identified. These results are shown in Table 1B.

### (Atmospheric Stability)

To evaluate atmospheric stability, the changes in the solid electrolytes of Sample Numbers 2, 13, 33, and 37 were each observed for 500 hours under an environment with a temperature range of 25° C.±10° C. (namely, temperature range of 15° C. or more and 35° C. or less) and a humidity range of 50% or more and 80% or less. The observed changes involved the presence or absence of collapse of the solid electrolyte and the percentage change in the ionic conductivity of the solid electrolyte. To observe the presence or absence of collapse, the solid electrolyte was left under the above environment. Moisture or carbon dioxide present in the atmosphere reacts with Li or a rare earth component contained in the solid electrolyte. As the reaction progresses, fine cracks develop on the surface of the solid electrolyte in the initial stage, and eventually, the solid electrolyte becomes pulverized. It should be noted that in the initial stage, the impact on the properties of the solid electrolyte was barely noticeable. The changes in the solid electrolyte over time were observed using a stereomicroscope (10× magnification). The time point at which fine cracks were detected was determined as the collapse time point. The results of the evaluation of atmospheric stability are shown in Table 2. The percentage change in ionic conductivity shown in Table 2 represents the percentage change in the ionic conductivity of the solid electrolyte measured after 500 hours relative to the ionic conductivity measured at 0 hours (i.e., the ionic conductivity measured when the solid electrolyte was obtained).

TABLE 1A

| | | | | Firing | Firing | Ionic | Sintered |
|---|---|---|---|---|---|---|---|
| Sample | | | | temperature | time | conductivity | density |
| Number | Chemical composition | x1 | y1 | ° C. | h | S/cm | g/cm³ |
| 1 | Li₇₍₁₊ₓ₁₎Pr₃Zr₂Sb_{y1}O_{12+3.5x1+1.5y1} | −0.05 | 0.2 | 1040 | 10 | 3.2 × 10⁻⁵ | 3.2 |
| 2 | Li₇₍₁₊ₓ₁₎Pr₃Zr₂Sb_{y1}O_{12+3.5x1+1.5y1} | 0 | 0.2 | 1000 | 2 | 1.7 × 10⁻⁵ | 3.12 |
| 3 | Li₇₍₁₊ₓ₁₎Pr₃Zr₂Sb_{y1}O_{12+3.5x1+1.5y1} | 0 | 0.2 | 1000 | 5 | 4.8 × 10⁻⁵ | 3.41 |
| 4 | Li₇₍₁₊ₓ₁₎Pr₃Zr₂Sb_{y1}O_{12+3.5x1+1.5y1} | 0 | 0.2 | 1000 | 10 | 1.9 × 10⁻⁴ | 3.82 |
| 5 | Li₇₍₁₊ₓ₁₎Pr₃Zr₂Sb_{y1}O_{12+3.5x1+1.5y1} | 0.02 | 0.2 | 1000 | 10 | 2.2 × 10⁻⁴ | 3.93 |
| 6 | Li₇₍₁₊ₓ₁₎Pr₃Zr₂Sb_{y1}O_{12+3.5x1+1.5y1} | 0.05 | 0.2 | 990 | 10 | 3.7 × 10⁻⁵ | 3.71 |
| 7 | Li₇₍₁₊ₓ₁₎Pr₃Zr₂Sb_{y1}O_{12+3.5x1+1.5y1} | 0.05 | 0.2 | 1000 | 10 | 4.5 × 10⁻⁴ | 3.96 |
| 8 | Li₇₍₁₊ₓ₁₎Pr₃Zr₂Sb_{y1}O_{12+3.5x1+1.5y1} | 0.1 | 0.2 | 990 | 10 | 4.9 × 10⁻⁴ | 4.04 |
| 9 | Li₇₍₁₊ₓ₁₎Pr₃Zr₂Sb_{y1}O_{12+3.5x1+1.5y1} | 0.15 | 0.2 | 985 | 10 | 5.2 × 10⁻⁴ | 4.14 |
| 10 | Li₇₍₁₊ₓ₁₎Pr₃Zr₂Sb_{y1}O_{12+3.5x1+1.5y1} | 0.2 | 0.2 | 940 | 10 | 6.5 × 10⁻⁵ | 3.68 |
| 11 | Li₇₍₁₊ₓ₁₎Pr₃Zr₂Sb_{y1}O_{12+3.5x1+1.5y1} | 0.2 | 0.2 | 950 | 10 | 8.1 × 10⁻⁵ | 3.78 |
| 12 | Li₇₍₁₊ₓ₁₎Pr₃Zr₂Sb_{y1}O_{12+3.5x1+1.5y1} | 0.2 | 0.2 | 970 | 10 | 6.8 × 10⁻⁴ | 4.07 |
| 13 | Li₇₍₁₊ₓ₁₎Pr₃Zr₂Sb_{y1}O_{12+3.5x1+1.5y1} | 0.2 | 0.2 | 1000 | 10 | 7.0 × 10⁻⁴ | 4.09 |
| 14 | Li₇₍₁₊ₓ₁₎Pr₃Zr₂Sb_{y1}O_{12+3.5x1+1.5y1} | 0.2 | 0.2 | 1030 | 10 | 7.7 × 10⁻⁵ | 4.12 |
| 15 | Li₇₍₁₊ₓ₁₎Pr₃Zr₂Sb_{y1}O_{12+3.5x1+1.5y1} | 0.25 | 0.2 | 960 | 10 | 6.3 × 10⁻⁴ | 4.17 |
| 16 | Li₇₍₁₊ₓ₁₎Pr₃Zr₂Sb_{y1}O_{12+3.5x1+1.5y1} | 0.3 | 0.2 | 950 | 10 | 6.2 × 10⁻⁴ | 4.18 |
| 17 | Li₇₍₁₊ₓ₁₎Pr₃Zr₂Sb_{y1}O_{12+3.5x1+1.5y1} | 0.35 | 0.2 | 940 | 10 | 3.5 × 10⁻⁵ | 4.19 |
| 18 | Li₇₍₁₊ₓ₁₎Pr₃Zr₂Sb_{y1}O_{12+3.5x1+1.5y1} | 0.25 | 0 | 940 | 10 | 3.3 × 10⁻⁶ | 2.88 |
| 19 | Li₇₍₁₊ₓ₁₎Pr₃Zr₂Sb_{y1}O_{12+3.5x1+1.5y1} | 0.25 | 0.1 | 940 | 10 | 6.3 × 10⁻⁴ | 3.98 |
| 20 | Li₇₍₁₊ₓ₁₎Pr₃Zr₂Sb_{y1}O_{12+3.5x1+1.5y1} | 0.25 | 0.2 | 940 | 10 | 5.7 × 10⁻⁴ | 3.93 |
| 21 | Li₇₍₁₊ₓ₁₎Pr₃Zr₂Sb_{y1}O_{12+3.5x1+1.5y1} | 0.25 | 0.3 | 940 | 10 | 5.1 × 10⁻⁴ | 3.54 |
| 22 | Li₇₍₁₊ₓ₁₎Pr₃Zr₂Sb_{y1}O_{12+3.5x1+1.5y1} | 0.25 | 0.4 | 940 | 10 | 3.4 × 10⁻⁴ | 3.21 |
| 23 | Li₇₍₁₊ₓ₁₎Pr₃Zr₂Sb_{y1}O_{12+3.5x1+1.5y1} | 0.25 | 0.5 | 940 | 10 | 1.1 × 10⁻⁴ | 2.71 |
| 24 | Li₇₍₁₊ₓ₁₎Pr₃Zr₂Sb_{y1}O_{12+3.5x1+1.5y1} | 0.25 | 0.6 | 940 | 10 | 8.8 × 10⁻⁶ | 2.21 |
| 25 | Li₇₍₁₊ₓ₁₎Pr₃Zr₂Sb_{y1}O_{12+3.5x1+1.5y1} | 0.1 | 0 | 940 | 10 | 2.5 × 10⁻⁶ | 2.76 |
| 26 | Li₇₍₁₊ₓ₁₎Pr₃Zr₂Sb_{y1}O_{12+3.5x1+1.5y1} | 0.1 | 0.3 | 940 | 10 | 3.8 × 10⁻⁴ | 3.21 |
| 27 | Li₇₍₁₊ₓ₁₎Pr₃Zr₂Sb_{y1}O_{12+3.5x1+1.5y1} | 0.1 | 0.5 | 940 | 10 | 0.8 × 10⁻⁴ | 2.7 |
| 28 | Li₇₍₁₊ₓ₁₎Pr₃Zr₂Sb_{y1}O_{12+3.5x1+1.5y1} | 0.1 | 0.6 | 940 | 10 | 7.3 × 10⁻⁶ | 2.18 |
| 29 | Li₇₍₁₊ₓ₁₎Pr₃Zr₂Sb_{y1}O_{12+3.5x1+1.5y1} | 0.35 | 0 | 940 | 10 | 2.1 × 10⁻⁶ | 2.79 |
| 30 | Li₇₍₁₊ₓ₁₎Pr₃Zr₂Sb_{y1}O_{12+3.5x1+1.5y1} | 0.35 | 0.3 | 940 | 10 | 3.6 × 10⁻⁴ | 3.31 |
| 31 | Li₇₍₁₊ₓ₁₎Pr₃Zr₂Sb_{y1}O_{12+3.5x1+1.5y1} | 0.35 | 0.5 | 940 | 10 | 1.0 × 10⁻⁴ | 2.74 |
| 32 | Li₇₍₁₊ₓ₁₎Pr₃Zr₂Sb_{y1}O_{12+3.5x1+1.5y1} | 0.35 | 0.6 | 940 | 10 | 5.8 × 10⁻⁶ | 2.2 |
| 33 | Li₇₍₁₊ₓ₁₎La₃Zr₂Sb_{y1}O_{12+3.5x1+1.5y1} | 0 | 0.2 | 1100 | 10 | 2.9 × 10⁻⁵ | 3.31 |
| 34 | Li₇₍₁₊ₓ₁₎La₃Zr₂Sb_{y1}O_{12+3.5x1+1.5y1} | 0 | 0.2 | 1150 | 10 | 4.7 × 10⁻⁴ | 3.82 |
| 35 | Li₇₍₁₊ₓ₁₎La₃Zr₂Sb_{y1}O_{12+3.5x1+1.5y1} | 0.1 | 0.2 | 1100 | 10 | 4.5 × 10⁻⁵ | 3.21 |
| 36 | Li₇₍₁₊ₓ₁₎La₃Zr₂Sb_{y1}O_{12+3.5x1+1.5y1} | 0.1 | 0.2 | 1150 | 10 | 5.1 × 10⁻⁵ | 3.41 |
| 37 | Li₇₍₁₊ₓ₁₎La₃Zr₂Sb_{y1}O_{12+3.5x1+1.5y1} | 0.2 | 0.2 | 1100 | 10 | 6.9 × 10⁻⁵ | 3.28 |
| 38 | Li₇₍₁₊ₓ₁₎La₃Zr₂Sb_{y1}O_{12+3.5x1+1.5y1} | 0.2 | 0.2 | 1150 | 10 | 6.1 × 10⁻⁵ | 3.43 |

TABLE 1B

| Sample | Crystalline phase (identified based on analysis |
|---|---|
| Number | results for interior and entire surface) |
| 1 | Pyrochlore (namely, Pr₂Zr₂O₇), Tetragonal system garnet |
| 2 | Pyrochlore, Tetragonal system garnet |
| 3 | Pyrochlore, Tetragonal system garnet, Cubic system garnet |
| 4 | Cubic system garnet |
| 5 | Cubic system garnet |
| 6 | Tetragonal system garnet, Cubic system garnet |
| 7 | Cubic system garnet |
| 8 | Cubic system garnet |
| 9 | Cubic system garnet |
| 10 | Pyrochlore, Tetragonal system garnet, Cubic system garnet |
| 11 | Tetragonal system garnet, Cubic system garnet |
| 12 | Cubic system garnet |
| 13 | Cubic system garnet |
| 14 | Cubic system garnet, Li₂ZrO₃, Li₂₆Pr₃₆O₇₃ |
| 15 | Cubic system garnet |
| 16 | Cubic system garnet |
| 17 | Cubic system garnet, Li₂ZrO₃, Li₂₆Pr₃₆O₇₃ |
| 18 | Pyrochlore, Tetragonal system garnet |
| 19 | Cubic system garnet |
| 20 | Cubic system garnet |
| 21 | Cubic system garnet |
| 22 | Cubic system garnet |
| 23 | Cubic system garnet, Li₂ZrO₃, Li₂₆Pr₃₆O₇₃ |
| 24 | Cubic system garnet, Li₂ZrO₃, Li₂₆Pr₃₆O₇₃ |
| 25 | Pyrochlore, Tetragonal system garnet |
| 26 | Cubic system garnet |
| 27 | Cubic system garnet |
| 28 | Cubic system garnet, Li₂ZrO₃, Li₂₆Pr₃₆O₇₃ |
| 29 | Pyrochlore, Tetragonal system garnet |
| 30 | Cubic system garnet |
| 31 | Cubic system garnet |
| 32 | Cubic system garnet, Li₂ZrO₃, Li₂₆Pr₃₆O₇₃ |
| 33 | Pyrochlore, Tetragonal system garnet, Cubic system garnet |
| 34 | Cubic system garnet |
| 35 | Cubic system garnet |
| 36 | Cubic system garnet |
| 37 | Cubic system garnet |
| 38 | Cubic system garnet, Li₂ZrO₃ |

TABLE 2

| | Presence or | | | | Percentage |
|---|---|---|---|---|---|
| Sample | Absence | Collapse | | Conductivity | change in |
| Number | of collapse | time | | at 500 h (S/cm) | conductivity/% |
| 2 | Absent | >500 | h | 1.68 × 10⁻⁵ | −1.18 |
| 13 | Absent | >500 | h | 7.01 × 10⁻⁴ | 0.14 |
| 33 | Present | 20 | h | No data due to collapse | |
| 37 | Absent | >500 | h | 4.87 × 10⁻⁵ | −29.4 |

The solid electrolytes of Sample Numbers 1 to 38 are described below with reference to Tables 1A and 1B. Sample Numbers 18, 25, and 29 are free of M (Sb) and are accordingly excluded from the solid electrolyte of the present disclosure. Sample Numbers 33 to 38 are free of Pr and are accordingly excluded from the solid electrolyte of the present disclosure.

The solid electrolytes of Sample Numbers 1 to 17, 19 to 24, 26 to 28, and 30 to 32 are each a solid electrolyte containing Li, Pr, Zr, O, and Sb and including a crystalline phase having a garnet-type crystal structure. The solid electrolytes of Sample Numbers 1 to 32 have the chemical composition Li₇₍₁₊ₓ₁₎α1₃β1₂₊ₐ₁Sb_{y1}O_{12+3.5x1+1.5y1+b1}, where α1 is Pr, β1 is Zr, a1 is equal to 0, and b1 is equal to 0. In other words, the solid electrolytes of Sample Numbers 1 to 32 have the chemical composition Li₇₍₁₊ₓ₁₎ Pr₃Zr₂Sb_{y1}O_{12+3.5x1+1.5y1}. The solid electrolytes of Sample Numbers 33 to 38 have the chemical composition Li₇₍₁₊ₓ₁₎La₃Zr₂Sb_{y1}O_{12+3.5x1+1.5y1}.

As is evident from Tables 1A and 1B, a Pr-containing compact having Sb added is sintered at a temperature lower than the temperatures at which a Sb-free compact and a Pr-free compact are sintered, resulting in a solid electrolyte containing Sb and Pr as constituent elements. The solid electrolytes of Sample Numbers 1 to 17, 19 to 24, 26 to 28, and 30 to 32 were each formed by sintering the compact at a low temperature and had a high ionic conductivity of 5.8×10⁻⁶ S/cm or more. The solid electrolytes of Sample Numbers 1 to 17, 19 to 23, 26, 27, 30, and 31 were each formed by sintering the compact at a low temperature and had a higher ionic conductivity (1×10⁻⁵ S/cm or more). The solid electrolytes of Sample Numbers 3 to 5, 7 to 16, 19 to 23, 26, 27, 30, and 31 each included a crystalline phase having a cubic-system garnet-type crystal structure and had an even higher ionic conductivity (4.8×10⁻⁵ S/cm or more), with a sintered density of 2.7 g/cm³ to 4.2 g/cm³. Additionally, solid electrolytes having a conventional Pr-based garnet-type crystal structure free of Sb have a sintered density of 3.3 g/cm³ to 4.5 g/cm³.

Furthermore, as is evident from the comparisons of Sample Numbers 19 to 23 with Sample Numbers 18 and 24, the comparisons of Sample Numbers 26 and 27 with Sample Numbers 25 and 28, and the comparisons of Sample Numbers 30 and 31 with Sample Numbers 29 and 32, the inclusion of Sb in the range of 0<y1≤0.5 can decrease the sintering temperature while higher ionic conductivity is maintained.

As is evident from comparing the solid electrolytes of Sample Numbers 4, 8, and 12 respectively with the solid electrolytes of Sample Numbers 33, 35, and 37, in the case where the values of x1 and y1 are the same, a solid electrolyte containing Pr as a constituent element is obtained by sintering at a sintering temperature at least approximately 100° C. lower than the sintering temperature of a solid electrolyte free of Pr as a constituent element and has higher ionic conductivity than a solid electrolyte free of Pr as a constituent element.

As is evident from comparing the solid electrolytes of Sample Numbers 1 to 17 with each other, in the solid electrolyte of the present disclosure, an increase in Li content (i.e., increase in the value of x1 from −0.05 to 0.35) results in a decrease in sintering temperature from 1040° C. to 940° C. while high ionic conductivity is exhibited. Furthermore, in the solid electrolyte of the present disclosure, there is a tendency for the density and the ionic conductivity to increase with the increase in Li content (i.e., increase in the value of x1 from −0.05 to 0.35). Therefore, in the case where the value of x1 is 0 or more and 0.35 or less, lower sintering temperatures, desired solid electrolyte density, and desired ionic conductivity can be achieved, and furthermore, fusion during firing can also be reduced.

On the other hand, as is evident from comparing the solid electrolytes of Sample Numbers 33 to 38 with each other, a La-based compact free of Pr, even with Sb contained, has a sintering temperature of 1100° C. or more. Furthermore, a La-based compact free of Pr has a sintering temperature of 1100° C. or more regardless of any increase in Li content.

From these results, the present inventors have found that a solid electrolyte containing Pr as a constituent element and a conventional solid electrolyte containing La as a constituent element differ from each other in terms of the mechanism during sintering, the crystalline phase of the solid electrolyte, and the dependence of electrical conductivity on composition. A solid electrolyte containing Pr as a constituent element and having a Pr-based garnet-type crystal structure can have a decreased sintering temperature with the addition of Sb.

For the solid electrolyte of Sample Number 2, a cubic-system garnet-type crystal structure was not observed. However, for the solid electrolytes of Sample Numbers 3 and 4, which have the same chemical composition as the composition of Sample Number 2, the firing time was extended. Consequently, a cubic-system garnet-type crystal structure was formed at the same firing temperature. In other words, while the solid electrolyte of Sample Number 2 did not exhibit a cubic-system garnet-type crystal structure, the solid electrolytes of Sample Numbers 3 and 4 exhibited a cubic-system garnet-type crystal structure. The compacts of Sample Numbers 2 to 4, which have the same chemical composition (namely, Li₇₍₁₊ₓ₁₎Pr₃Zr₂Sb_{y1}O_{12+3.5x1+1.5y1}, where x1=0 and y1=0.2), were sintered at the same temperature (namely, 1000° C.); however, it should be noted that their firing times differ from each other.

Next, the atmospheric stability of the solid electrolytes is described with reference to Table 2. The solid electrolytes of Sample Numbers 2 and 13 are compared with the solid electrolytes of Sample Numbers 33 and 37. The solid electrolytes of Sample Numbers 2 and 13 have the chemical composition Li₇₍₁₊ₓ₁₎Pr₃Zr₂Sb_{y1}O_{12+3.5x1+1.5y1}. In other words, the solid electrolytes of Sample Numbers 2 and 13 are each a solid electrolyte having a Pr-based garnet-type crystal structure containing Sb. The solid electrolytes of Sample Numbers 33 and 37 have the chemical composition Li₇₍₁₊ₓ₁₎La₃Zr₂Sb_{y1}O_{12+3.5x1+1.5y1}. In other words, the solid electrolytes of Sample Numbers 33 and 37 are each a solid electrolyte having a La-based garnet-type crystal structure containing Sb.

It is known that a sintered body having a La-based garnet-type crystal structure tends to form an unnecessary phase composed of a trace amount of pyrochlore structure. Here, the solid electrolytes of Sample Number 2 (i.e., the example) and Sample Number 33 (i.e., the comparative example) both include a pyrochlore phase. However, as is evident from Table 2, the solid electrolyte of Sample Number 2 did not collapse even after 500 hours, whereas the solid electrolyte of Sample Number 33 collapsed after 20 hours. Therefore, a solid electrolyte having a Pr-based garnet-type crystal structure has more excellent atmospheric stability than a solid electrolyte having a La-based garnet-type crystal structure.

The solid electrolytes of Sample Number 13 (i.e., the example) and Sample Number 37 (i.e., the comparative example) were each determined to be composed of a single phase of a cubic-system garnet-type crystal structure as in the X-ray diffraction pattern. However, the ionic conductivity of the solid electrolyte of Sample Number 13 was almost constant before and after 500 hours, whereas the ionic conductivity of the solid electrolyte of Sample Number 37 significantly decreased after 500 hours. Thus, the solid electrolyte of Sample Number 13 has more excellent atmospheric stability than the solid electrolyte of Sample Number 37. It should be noted that the solid electrolytes of Sample Number 13 (i.e., the example) and Sample Number 37 (i.e., the comparative example) both may include a trace amount of a pyrochlore phase that is not detectable by X-ray diffraction.

The reasons for the differences in properties between solid electrolytes containing Pr and solid electrolytes containing La and free of Pr, along with their effective actions, are described in detail below.

As described above, there is a tendency that, when a Li-based material is sintered at a high firing temperature, the evaporation of Li causes segregation of a Li-deficient crystalline phase (e.g., pyrochlore phase (La₂Zr₂O₇)) at the grain boundaries. The segregated Li-deficient crystalline phase, even in a trace amount, is decomposed by reaction with at least one selected from the group consisting of moisture and carbon dioxide in the atmosphere. This causes the crystalline phase to expand. The expansion generates cracks between the crystal particles having a garnet-type crystal structure, and eventually, the sintered body collapses. On the other hand, the compacts of Sample Numbers 1 to 17, 19 to 24, 26 to 28, and 30 to 32 containing Sb and Pr as constituent elements in the examples were sintered at lower temperatures than the temperature at which a compact containing Sb and La is sintered. Consequently, the evaporation of the components contained in each of the compacts during sintering was suppressed, thereby improving the atmospheric stability of the solid electrolyte despite the fact that the sintered body has low density, that is, the sintered body is prone to the intrusion of moisture and the like. Thus, in the solid electrolytes of the examples containing Pr as a constituent element, the evaporation of the components contained in the compacts during sintering is suppressed, thereby improving atmospheric stability.

As shown in Table 2, the solid electrolytes of Sample Numbers 2 and 13 did not collapse even after being left for 500 hours at a temperature of 15° C. or more and 35° C. or less and a humidity of 50% or more and 80% or less. In contrast, the solid electrolyte of Sample Number 33 collapsed in 20 hours under the same conditions. The solid electrolyte of Sample Number 37 exhibited significantly decreased ionic conductivity after 500 hours. Thus, a solid electrolyte containing Pr has been found to have inherently much higher atmospheric stability than a solid electrolyte free of Pr.

Furthermore, as in the solid electrolyte of Sample Number 2, even in the case where a solid electrolyte includes a trace amount of a Pr—Zr-based pyrochlore phase between crystalline phases having a Pr-based garnet-type crystal structure, the solid electrolyte has high stability.

As described above, in the case where the Li content is in excess, that is, in the case where x1>0 is satisfied in the composition formula Li₇₍₁₊ₓ₁₎Pr₃Zr₂Sb_{y1}O_{12+3.5x1+1.5y1}, sintering and changes in crystalline phase are more likely to progress from lower temperatures than in the case where x1=0 is satisfied. Consequently, a cubic-system garnet-type crystal structure is stably formed and the ionic conductivity is also increased. For example, in Sample Number 12 (x1=0.2), the sintering temperature is 970° C., resulting in a solid electrolyte composed of a single phase of a cubic-system garnet-type crystal structure. The solid electrolyte has a good ionic conductivity of 6.8×10⁻⁴ S/cm at a density of 4.07 g/cm³. Furthermore, the solid electrolyte of Sample Number 17 (x1=0.35) has an ionic conductivity of 3.5×10⁻⁵ S/cm. In contrast, the solid electrolyte of Sample Number 16 (x1=0.3) has an ionic conductivity of 6.2×10⁻⁴ S/cm. The solid electrolyte of Sample Number 16 has higher ionic conductivity than the solid electrolyte of Sample Number 17. Therefore, in the case where the value of x1 is 0.3 or less, higher ionic conductivity can be achieved than in the case where the value of x1 exceeds 0.3. As described above, high Li content causes a fusion issue of the solid electrolyte due to excessive sintering in some cases. In the case where the value of x1 is 0.3 or less, the occurrence of fusion of the solid electrolyte is more reliably suppressed than in the case where the value of x1 exceeds 0.3.

In the composition formula Li₇₍₁₊ₓ₁₎Pr₃Zr₂Sb_{y1}O_{12+3.5x1+1.5y1}, the value of x1 is −0.05 or more and 0.35 or less. As described above, from the three viewpoints of decreasing the sintering temperature, improving the ionic conductivity, and suppressing the occurrence of a fusion issue due to excessive sintering, the value of x1 may be 0 or more and 0.35 or less or more than 0 and 0.3 or less.

Additionally, for the solid electrolyte of Sample Number 14, cubic-system garnet-type, Li₂ZrO₃, and Li₂₆Pr₃₆O₇₃ crystal structures were detected by powder X-ray diffraction. This detection result suggests that a portion of the crystalline phase having a cubic-system garnet-type crystal structure is decomposed on the surface of the solid electrolyte. The solid electrolyte of Sample Number 14 has lower electrical conductivity than the solid electrolytes of Sample Numbers 12 and 13. It should be noted that the solid electrolytes of Sample Numbers 12 to 14 have the same chemical composition. The present inventors believe that the lower electrical conductivity of Sample Number 14 is due to its high Li content (i.e., x1=0.2) and the sintering of the compact at 1030° C., which is a higher temperature than those of Sample Numbers 12 and 13.

### Sample Numbers 39 to 76

### <Method for Producing Solid Electrolyte Evaluation Sample>

Solid electrolyte evaluation samples with the chemical compositions shown in Table 3A were each produced by the following method.

### Sample Numbers 39 to 70

First, Li₂CO₃ powder, Pr₆O₁₁ powder, ZrO₂ powder, and Bi₂O₃ powder were prepared as the raw materials. Subsequently, the mass of the raw materials was measured to obtain the chemical composition of the solid electrolyte shown in Table 3A.

Next, these powders were placed in a polyethylene ball mill. Stabilized zirconia balls and pure water were added to the ball mill to obtain a mixture. The balls had a diameter of 5 millimeters. The mixture was ground for approximately 20 hours. The ground raw material had an average particle diameter of 0.61 micrometers.

Subsequently, the ground mixture was dehydrated and then dried to obtain a powder.

The dried powder was placed in a high-purity alumina crucible and then the crucible was covered with a lid. The dried powder was calcined at approximately 750° C. for 2 hours.

Subsequently, the calcined powder was placed in a polyethylene ball mill.

Stabilized zirconia balls and pure water were added to the ball mill to obtain a mixture. The balls had a diameter of 5 millimeters. The mixture was ground for approximately 20 hours. The ground powder had an average particle diameter of 0.89 micrometers.

Subsequently, the ground mixture was thoroughly dehydrated and then dried to obtain a powder.

Next, polyvinyl alcohol was added to the dried powder and mixed to obtain a mixture. The polyvinyl alcohol served as an organic binder. The powder was dispersed within the mixture, and then the mixture was classified through a filter with a square mesh having a spacing of 0.50 millimeters to obtain particles that passed through the filter. Subsequently, the particles were dried to remove moisture contained in the particles. The powder was then pressured at a pressure of 2 t/cm² using a die and a uniaxial hydraulic press to obtain a compact. The compact had the shape of a disc with a diameter of 13 millimeters and a thickness of 1.3 millimeters.

The compact was placed in a heat-resistant alumina container and sintered. Before the compact was placed in the container, zirconia powder was uniformly spread on the bottom of the container to prevent direct contact between the compact and the bottom of the container. The zirconia powder had an average particle size of 50 micrometers. Furthermore, a calcined powder having the same composition as the compact to be sintered was spread on the zirconia powder, and then the compact was placed on the calcined powder spread. The calcined powder is further supplied to the container and surrounded the compact such that the compact would be embedded in the calcined powder. The interior of the container was then heated to 450° C. to remove the organic binder (namely, polyvinyl alcohol). After this, a lid polished smoothly with #800 sandpaper was put onto the container to seal the container. The compact was then sintered at the firing temperature and firing time shown in Table 3A to obtain a solid electrolyte. Additionally, a preliminary test was performed to set the firing temperature for each of the samples. In this test, the temperature range, at which the shrinkage rate of the compact having the composition of the sample had reached its maximum value during its temperature increase, was identified to determine the sintering temperature of the sample.

On each of the upper and lower surfaces of the solid electrolyte, an electrode having the shape of a circle with a diameter of 6 millimeters (i.e., circle with an area of approximately 28.26 square millimeters per surface) was formed by Au deposition. Thus, the solid electrolyte evaluation samples in the examples were obtained.

### Sample Numbers 71 to 76

The raw materials used were Li₂CO₃ powder, La₂O₃ powder, ZrO₂ powder, and Bi₂O₃ powder. Except for this, the same procedure as for Sample Numbers 39 to 70 was performed to obtain the solid electrolyte evaluation samples of Sample Numbers 71 to 76.

The average particle diameter of the raw materials is represented by the value of the median diameter D50 determined from a volume-based particle size distribution measured using a laser diffraction scattering particle size analyzer. Specifically, the sample powder was dispersed in a 0.01 wt % Na hexametaphosphate aqueous solution using a homogenizer. The particle size distribution of the sample powder was then measured using a laser diffraction scattering particle size analyzer (manufactured by MicrotracBEL Corp., trade name: MT3100II). The value of D50 (i.e., cumulative 50% particle diameter) in the measured particle size distribution was considered as the average particle diameter. The average particle diameter of the calcined powder is also represented by the value of D50 thereof.

### <Evaluation of Solid Electrolyte>

The ionic conductivity of each of the solid electrolyte samples was measured as follows. Furthermore, the density of the solid electrolyte was calculated. Moreover, the crystalline phase of the solid electrolyte was identified. The solid electrolyte samples of Sample Numbers 40, 51, 71, and 75 were further evaluated for atmospheric stability.

### (Ionic Conductivity)

The ionic conductivity of the solid electrolyte was calculated from the impedance characteristics, thickness, and electrode area (namely, approximately 28.26 square millimeters) of the solid electrolyte. The impedance characteristics of the solid electrolyte were measured using an impedance measurement system (manufactured by Solartron Analytical Ltd., trade name: 12608W) in a thermostatic chamber maintained at 24° C. to 26° C., within a measurement frequency range of 10 Hz to 10 MHZ.

### (Density)

The density (sintered density) of the solid electrolyte was calculated by dividing the mass of the solid electrolyte by the volume determined from the overall dimensions of the solid electrolyte.

### (Identification of Crystalline Phase)

The crystalline phase of the solid electrolyte was identified on the basis of both the analysis result of the crystalline phase of the interior of the solid electrolyte and the analysis result of the crystalline phase of the entire surface of the solid electrolyte.

The crystalline phase of the interior of the solid electrolyte was identified as follows. First, the solid electrolyte was finely ground in an agate mortar. The ground solid electrolyte was then subjected to X-ray diffraction analysis with an X-ray diffractometer (manufactured by Rigaku Corporation) using CuKα radiation to obtain an X-ray diffraction pattern at room temperature. On the basis of the analysis result of the X-ray diffraction pattern, the crystalline phase of the interior of the solid electrolyte was identified.

The crystalline phase of the entire surface of the solid electrolyte was identified as follows. The X-ray diffraction pattern of the free surface (i.e., the surface that had not been processed after sintering) of the solid electrolyte was obtained in the same manner as for the analysis of the crystalline phase of the interior of the solid electrolyte. Then, on the basis of the analysis result of the X-ray diffraction pattern, the crystalline phase of the entire surface of the solid electrolyte was identified. These results are shown in Table 3B.

### (Atmospheric Stability)

To evaluate atmospheric stability, the changes in the solid electrolytes of Sample Numbers 40, 51, 71, and 75 were each observed for 500 hours under an environment with a temperature range of 25° C.±10° C. (namely, temperature range of 15° C. or more and 35° C. or less) and a humidity range of 50% or more and 80% or less. The observed changes involved the presence or absence of collapse of the solid electrolyte and the percentage change in the ionic conductivity of the solid electrolyte. To observe the presence or absence of collapse, the solid electrolyte was left under the above environment. Moisture or carbon dioxide present in the atmosphere reacts with Li or a rare earth component contained in the solid electrolyte. As the reaction progresses, fine cracks develop on the surface of the solid electrolyte in the initial stage, and eventually, the solid electrolyte becomes pulverized. It should be noted that in the initial stage, the impact on the properties of the solid electrolyte was barely noticeable. The changes in the solid electrolyte over time were observed using a stereomicroscope (10× magnification). The time point at which fine cracks were detected was determined as the collapse time point. The results of the evaluation of atmospheric stability are shown in Table 4. The percentage change in ionic conductivity shown in Table 4 represents the percentage change in the ionic conductivity of the solid electrolyte measured after 500 hours relative to the ionic conductivity measured at 0 hours (i.e., the ionic conductivity measured when the solid electrolyte was obtained).

TABLE 3A

| | | | | Firing | Firing | Ionic | Sintered |
|---|---|---|---|---|---|---|---|
| Sample | | | | temperature | time | conductivity | density |
| Number | Chemical composition | x2 | y2 | ° C. | h | S/cm | g/cm³ |
| 39 | Li₇₍₁₊ₓ₂₎Pr₃Zr₂Bi_{y2}O_{12+3.5x2+1.5y2} | −0.05 | 0.2 | 1040 | 10 | 3.1 × 10⁻⁵ | 3.49 |
| 40 | Li₇₍₁₊ₓ₂₎Pr₃Zr₂Bi_{y2}O_{12+3.5x2+1.5y2} | 0 | 0.2 | 1000 | 2 | 1.5 × 10⁻⁵ | 3.37 |
| 41 | Li₇₍₁₊ₓ₂₎Pr₃Zr₂Bi_{y2}O_{12+3.5x2+1.5y2} | 0 | 0.2 | 1000 | 5 | 4.6 × 10⁻⁵ | 3.66 |
| 42 | Li₇₍₁₊ₓ₂₎Pr₃Zr₂Bi_{y2}O_{12+3.5x2+1.5y2} | 0 | 0.2 | 1000 | 10 | 1.8 × 10⁻⁴ | 3.96 |
| 43 | Li₇₍₁₊ₓ₂₎Pr₃Zr₂Bi_{y2}O_{12+3.5x2+1.5y2} | 0.02 | 0.2 | 1000 | 10 | 2.0 × 10⁻⁴ | 4.05 |
| 44 | Li₇₍₁₊ₓ₂₎Pr₃Zr₂Bi_{y2}O_{12+3.5x2+1.5y2} | 0.05 | 0.2 | 990 | 10 | 3.5 × 10⁻⁵ | 3.81 |
| 45 | Li₇₍₁₊ₓ₂₎Pr₃Zr₂Bi_{y2}O_{12+3.5x2+1.5y2} | 0.05 | 0.2 | 1000 | 10 | 4.5 × 10⁻⁴ | 4.07 |
| 46 | Li₇₍₁₊ₓ₂₎Pr₃Zr₂Bi_{y2}O_{12+3.5x2+1.5y2} | 0.1 | 0.2 | 990 | 10 | 4.6 × 10⁻⁴ | 4.13 |
| 47 | Li₇₍₁₊ₓ₂₎Pr₃Zr₂Bi_{y2}O_{12+3.5x2+1.5y2} | 0.15 | 0.2 | 985 | 10 | 5.0 × 10⁻⁴ | 4.2 |
| 48 | Li₇₍₁₊ₓ₂₎Pr₃Zr₂Bi_{y2}O_{12+3.5x2+1.5y2} | 0.2 | 0.2 | 940 | 10 | 6.4 × 10⁻⁵ | 3.8 |
| 49 | Li₇₍₁₊ₓ₂₎Pr₃Zr₂Bi_{y2}O_{12+3.5x2+1.5y2} | 0.2 | 0.2 | 950 | 10 | 7.9 × 10⁻⁵ | 3.86 |
| 50 | Li₇₍₁₊ₓ₂₎Pr₃Zr₂Bi_{y2}O_{12+3.5x2+1.5y2} | 0.2 | 0.2 | 970 | 10 | 6.7 × 10⁻⁴ | 4.14 |
| 51 | Li₇₍₁₊ₓ₂₎Pr₃Zr₂Bi_{y2}O_{12+3.5x2+1.5y2} | 0.2 | 0.2 | 1000 | 10 | 6.8 × 10⁻⁴ | 4.15 |
| 52 | Li₇₍₁₊ₓ₂₎Pr₃Zr₂Bi_{y2}O_{12+3.5x2+1.5y2} | 0.2 | 0.2 | 1030 | 10 | 7.6 × 10⁻⁵ | 4.17 |
| 53 | Li₇₍₁₊ₓ₂₎Pr₃Zr₂Bi_{y2}O_{12+3.5x2+1.5y2} | 0.25 | 0.2 | 960 | 10 | 6.0 × 10⁻⁴ | 4.2 |
| 54 | Li₇₍₁₊ₓ₂₎Pr₃Zr₂Bi_{y2}O_{12+3.5x2+1.5y2} | 0.3 | 0.2 | 950 | 10 | 5.9 × 10⁻⁴ | 4.21 |
| 55 | Li₇₍₁₊ₓ₂₎Pr₃Zr₂Bi_{y2}O_{12+3.5x2+1.5y2} | 0.35 | 0.2 | 940 | 10 | 3.3 × 10⁻⁵ | 4.22 |
| 56 | Li₇₍₁₊ₓ₂₎Pr₃Zr₂Bi_{y2}O_{12+3.5x2+1.5y2} | 0.25 | 0 | 940 | 10 | 3.3 × 10⁻⁶ | 2.88 |
| 57 | Li₇₍₁₊ₓ₂₎Pr₃Zr₂Bi_{y2}O_{12+3.5x2+1.5y2} | 0.25 | 0.1 | 940 | 10 | 5.9 × 10⁻⁴ | 3.76 |
| 58 | Li₇₍₁₊ₓ₂₎Pr₃Zr₂Bi_{y2}O_{12+3.5x2+1.5y2} | 0.25 | 0.2 | 940 | 10 | 5.4 × 10⁻⁴ | 3.97 |
| 59 | Li₇₍₁₊ₓ₂₎Pr₃Zr₂Bi_{y2}O_{12+3.5x2+1.5y2} | 0.25 | 0.26 | 940 | 10 | 5.9 × 10⁻⁴ | 4.12 |
| 60 | Li₇₍₁₊ₓ₂₎Pr₃Zr₂Bi_{y2}O_{12+3.5x2+1.5y2} | 0.25 | 0.34 | 940 | 10 | 5.8 × 10⁻⁴ | 4.2 |
| 61 | Li₇₍₁₊ₓ₂₎Pr₃Zr₂Bi_{y2}O_{12+3.5x2+1.5y2} | 0.25 | 0.4 | 940 | 10 | 5.4 × 10⁻⁴ | 4.25 |
| 62 | Li₇₍₁₊ₓ₂₎Pr₃Zr₂Bi_{y2}O_{12+3.5x2+1.5y2} | 0.25 | 0.46 | 940 | 10 | 9.2 × 10⁻⁶ | 4.28 |
| 63 | Li₇₍₁₊ₓ₂₎Pr₃Zr₂Bi_{y2}O_{12+3.5x2+1.5y2} | 0.1 | 0 | 940 | 10 | 2.5 × 10⁻⁶ | 2.76 |
| 64 | Li₇₍₁₊ₓ₂₎Pr₃Zr₂Bi_{y2}O_{12+3.5x2+1.5y2} | 0.1 | 0.26 | 940 | 10 | 4.1 × 10⁻⁴ | 4.21 |
| 65 | Li₇₍₁₊ₓ₂₎Pr₃Zr₂Bi_{y2}O_{12+3.5x2+1.5y2} | 0.1 | 0.4 | 940 | 10 | 5.9 × 10⁻⁴ | 4.25 |
| 66 | Li₇₍₁₊ₓ₂₎Pr₃Zr₂Bi_{y2}O_{12+3.5x2+1.5y2} | 0.1 | 0.46 | 940 | 10 | 7.5 × 10⁻⁶ | 2.18 |
| 67 | Li₇₍₁₊ₓ₂₎Pr₃Zr₂Bi_{y2}O_{12+3.5x2+1.5y2} | 0.35 | 0 | 940 | 10 | 2.1 × 10⁻⁶ | 2.79 |
| 68 | Li₇₍₁₊ₓ₂₎Pr₃Zr₂Bi_{y2}O_{12+3.5x2+1.5y2} | 0.35 | 0.26 | 940 | 10 | 5.3 × 10⁻⁴ | 4.22 |
| 69 | Li₇₍₁₊ₓ₂₎Pr₃Zr₂Bi_{y2}O_{12+3.5x2+1.5y2} | 0.35 | 0.4 | 940 | 10 | 5.7 × 10⁻⁴ | 4.27 |
| 70 | Li₇₍₁₊ₓ₂₎Pr₃Zr₂Bi_{y2}O_{12+3.5x2+1.5y2} | 0.35 | 0.46 | 940 | 10 | 5.8 × 10⁻⁶ | 2.2 |
| 71 | Li₇₍₁₊ₓ₂₎La₃Zr₂Bi_{y2}O_{12+3.5x2+1.5y2} | 0 | 0.2 | 1100 | 10 | 2.7 × 10⁻⁵ | 3.33 |
| 72 | Li₇₍₁₊ₓ₂₎La₃Zr₂Bi_{y2}O_{12+3.5x2+1.5y2} | 0 | 0.2 | 1150 | 10 | 4.3 × 10⁻⁴ | 3.8 |
| 73 | Li₇₍₁₊ₓ₂₎La₃Zr₂Bi_{y2}O_{12+3.5x2+1.5y2} | 0.1 | 0.2 | 1100 | 10 | 4.2 × 10⁻⁵ | 3.3 |
| 74 | Li₇₍₁₊ₓ₂₎La₃Zr₂Bi_{y2}O_{12+3.5x2+1.5y2} | 0.1 | 0.2 | 1150 | 10 | 5.7 × 10⁻⁵ | 3.71 |
| 75 | Li₇₍₁₊ₓ₂₎La₃Zr₂Bi_{y2}O_{12+3.5x2+1.5y2} | 0.2 | 0.2 | 1100 | 10 | 6.8 × 10⁻⁵ | 3.31 |
| 76 | Li₇₍₁₊ₓ₂₎La₃Zr₂Bi_{y2}O_{12+3.5x2+1.5y2} | 0.2 | 0.2 | 1150 | 10 | 6.5 × 10⁻⁵ | 3.77 |

TABLE 3B

| Sample | Crystalline phase (identified based on analysis |
|---|---|
| Number | results for interior and entire surface) |
| 39 | Pyrochlore (namely, Pr₂Zr₂O₇), Tetragonal system garnet |
| 40 | Pyrochlore, Tetragonal system garnet |
| 41 | Pyrochlore, Tetragonal system garnet, Cubic system garnet |
| 42 | Cubic system garnet |
| 43 | Cubic system garnet |
| 44 | Tetragonal system garnet, Cubic system garnet |
| 45 | Cubic system garnet |
| 46 | Cubic system garnet |
| 47 | Cubic system garnet |
| 48 | Pyrochlore, Tetragonal system garnet, Cubic system garnet |
| 49 | Tetragonal system garnet, Cubic system garnet |
| 50 | Cubic system garnet |
| 51 | Cubic system garnet |
| 52 | Cubic system garnet, Li₂ZrO₃, PrO₂ |
| 53 | Cubic system garnet |
| 54 | Cubic system garnet |
| 55 | Cubic system garnet, Li₂ZrO₃, PrO₂ |
| 56 | Pyrochlore, Tetragonal system garnet |
| 57 | Cubic system garnet |
| 58 | Cubic system garnet |
| 59 | Cubic system garnet |
| 60 | Cubic system garnet |
| 61 | Cubic system garnet, Li₂ZrO₃, PrO₂ |
| 62 | Cubic system garnet, Li₂ZrO₃, PrO₂ |
| 63 | Pyrochlore, Tetragonal system garnet |
| 64 | Cubic system garnet |
| 65 | Cubic system garnet |
| 66 | Cubic system garnet, Li₂ZrO₃, PrO₂ |
| 67 | Pyrochlore, Tetragonal system garnet |
| 68 | Cubic system garnet |
| 69 | Cubic system garnet |
| 70 | Cubic system garnet, Li₂ZrO3, PrO₂ |
| 71 | Pyrochlore, Tetragonal system garnet, Cubic system garnet |
| 72 | Cubic system garnet |
| 73 | Cubic system garnet |
| 74 | Cubic system garnet |
| 75 | Cubic system garnet |
| 76 | Cubic system garnet, Li₂ZrO₃ |

TABLE 4

| | Presence or | | | Conductivity | Percentage |
|---|---|---|---|---|---|
| Sample | Absence | Collapse | | at 500 h | change in |
| Number | of collapse | time | | (S/cm) | conductivity/% |
| 40 | Absent | >500 | h | 1.49 × 10⁻⁵ | −0.7 |
| 51 | Absent | >500 | h | 6.82 × 10⁻⁴ | 0.29 |
| 71 | Present | 20 | h | No data due to collapse | |
| 75 | Present | >500 | h | 4.69 × 10⁻⁵ | −31.0 |

The solid electrolytes of Sample Numbers 39 to 76 are described below with reference to Tables 3A and 3B. Sample Numbers 56, 63, and 67 are free of M (Bi) and are accordingly excluded from the solid electrolyte of the present disclosure. Sample Numbers 71 to 76 are free of Pr and are accordingly excluded from the solid electrolyte of the present disclosure.

The solid electrolytes of Sample Numbers 39 to 55, 57 to 62, 64 to 66, and 68 to 70 are each a solid electrolyte containing Li, Pr, Zr, O, and Bi and including a crystalline phase having a garnet-type crystal structure. The solid electrolytes of Sample Numbers 39 to 70 have the chemical composition Li₇₍₁₊ₓ₂₎α2₃β2₂₊ₐ₂Bi_{y2}O_{12+3.5x2+1.5y2+b2}, where α2 is Pr, β2 is Zr, a2 is equal to 0, and b2 is equal to 0. In other words, the solid electrolytes of Sample Numbers 39 to 70 have the chemical composition Li₇₍₁₊ₓ₂₎Pr₃Zr₂Bi_{y2}O_{12+3.5x2+1.5y2}. The solid electrolytes of Sample Numbers 71 to 76 have the chemical composition Li₇₍₁₊ₓ₂₎La₃Zr₂Bi_{y2}O_{12+3.5x2+1.5y2}.

As is evident from Tables 3A and 3B, a Pr-containing compact having Bi added is sintered at a temperature lower than the temperatures at which a Bi-free compact and a Pr-free compact are sintered, resulting in a solid electrolyte containing Bi and Pr as constituent elements. The solid electrolytes of Sample Numbers 39 to 55, 57 to 62, 64 to 66, and 68 to 70 were each formed by sintering the compact at a low temperature and had a high ionic conductivity of 5.8×10⁻⁶ S/cm or more. The solid electrolytes of Sample Numbers 39 to 55, 57 to 61, 64, 65, 68 and 69 were each formed by sintering the compact at a low temperature and had a higher ionic conductivity (1×10⁻⁵ S/cm or more). The solid electrolytes of Sample Numbers 41 to 55, 57 to 61, 64, 65, 68, and 69 each included a crystalline phase having a cubic-system garnet-type crystal structure and had an even higher ionic conductivity (3.3×10⁻⁵ S/cm or more). The sintered density at that time was 3.66 g/cm³ to 4.27 g/cm³ and was higher than the sintered densities of the solid electrolytes obtained in Sample Numbers 56, 63, and 67 free of Bi. Additionally, the solid electrolytes obtained in Sample Numbers 56, 63, and 67 free of Bi each had a sintered density of 2.76 g/cm³ to 2.88 g/cm³.

Furthermore, as is evident from the comparisons of Sample Numbers 57 to 61 with Sample Numbers 56 and 62, the comparisons of Sample Numbers 64 and 65 with Sample Numbers 63 and 66, and the comparisons of Sample Numbers 68 and 69 with Sample Numbers 67 and 70, the inclusion of Bi in the range of 0<y2≤0.4 can decrease the sintering temperature while higher ionic conductivity is maintained. Moreover, according to the above, it is possible to suppress the evident emergence of the influence of a precipitated phase such as Li₂ZrO₃ or PrO₂, thereby achieving high sintered density and mechanical reliability.

As is evident from comparing the solid electrolytes of Sample Numbers 42, 46, and 50 respectively with the solid electrolytes of Sample Numbers 71, 73, and 75, in the case where the values of x2 and y2 are the same, a solid electrolyte containing Pr as a constituent element is obtained by sintering at a sintering temperature at least approximately 100° C. lower than the sintering temperature of a solid electrolyte free of Pr as a constituent element and has higher ionic conductivity than a solid electrolyte free of Pr as a constituent element.

As is evident from comparing the solid electrolytes of Sample Numbers 39 to 55 with each other, in the solid electrolyte of the present disclosure, an increase in Li content (i.e., increase in the value of x2 from −0.05 to 0.35) results in a decrease in sintering temperature from 1040° C. to 940° C. while high ionic conductivity is exhibited. Furthermore, in the solid electrolyte of the present disclosure, there is a tendency for the density and the ionic conductivity to increase with the increase in Li content (i.e., increase in the value of x2 from −0.05 to 0.35). Therefore, in the case where the value of x2 is 0 or more and 0.35 or less, lower sintering temperatures, desired solid electrolyte density, and desired ionic conductivity can be achieved, and furthermore, fusion during firing can also be reduced.

On the other hand, as is evident from comparing the solid electrolytes of Sample Numbers 71 to 76 with each other, a La-based compact free of Pr, even with Bi contained, has a sintering temperature of 1100° C. or more. Furthermore, a La-based compact free of Pr has a sintering temperature of 1100° C. or more regardless of any increase in Li content.

From these results, the present inventors have found that a solid electrolyte containing Pr as a constituent element and a conventional solid electrolyte containing La as a constituent element differ from each other in terms of the mechanism during sintering, the crystalline phase of the solid electrolyte, and the dependence of electrical conductivity on composition. A solid electrolyte containing Pr as a constituent element and having a Pr-based garnet-type crystal structure can have a decreased sintering temperature with the addition of Bi.

For the solid electrolyte of Sample Number 40, a cubic-system garnet-type crystal structure was not observed. However, for the solid electrolytes of Sample Numbers 41 and 42, which have the same chemical composition as the composition of Sample Number 40, the firing time was extended. Consequently, a cubic-system garnet-type crystal structure was formed at the same firing temperature. In other words, while the solid electrolyte of Sample Number 40 did not exhibit a cubic-system garnet-type crystal structure, the solid electrolytes of Sample Numbers 41 and 42 exhibited a cubic-system garnet-type crystal structure. The compacts of Sample Numbers 40 to 42, which have the same chemical composition (namely, Li₇₍₁₊ₓ₂₎Pr₃Zr₂Bi_{y2}O_{12+3.5x2+1.5y2}, where x2=0 and y2=0.2), were sintered at the same temperature (namely, 1000° C.); however, it should be noted that their firing times differ from each other.

Next, the atmospheric stability of the solid electrolytes is described with reference to Table 4. The solid electrolytes of Sample Numbers 40 and 51 are compared with the solid electrolytes of Sample Numbers 71 and 75. The solid electrolytes of Sample Numbers 40 and 51 have the chemical composition Li₇₍₁₊ₓ₂₎Pr₃Zr₂Bi_{y2}O_{12+3.5x2+1.5y2}. In other words, the solid electrolytes of Sample Numbers 40 and 51 are each a solid electrolyte having a Pr-based garnet-type crystal structure containing Bi. The solid electrolytes of Sample Numbers 71 and 75 have the chemical composition Li₇₍₁₊ₓ₂₎La₃Zr₂Bi_{y2}O_{12+3.5x2+1.5y2}. In other words, the solid electrolytes of Sample Numbers 71 and 75 are each a solid electrolyte having a La-based garnet-type crystal structure containing Bi.

It is known that a sintered body having a La-based garnet-type crystal structure tends to form an unnecessary phase composed of a trace amount of pyrochlore structure. Here, the solid electrolytes of Sample Number 40 (i.e., the example) and Sample Number 71 (i.e., the comparative example) both include a pyrochlore phase. However, as is evident from Table 4, the solid electrolyte of Sample Number 40 did not collapse even after 500 hours, whereas the solid electrolyte of Sample Number 71 collapsed after 20 hours. Therefore, a solid electrolyte having a Pr-based garnet-type crystal structure has more excellent atmospheric stability than a solid electrolyte having a La-based garnet-type crystal structure.

The solid electrolytes of Sample Number 51 (i.e., the example) and Sample Number 75 (i.e., the comparative example) were each determined to be composed of a single phase of a cubic-system garnet-type crystal structure as in the X-ray diffraction pattern. However, the ionic conductivity of the solid electrolyte of Sample Number 51 was almost constant before and after 500 hours, whereas the ionic conductivity of the solid electrolyte of Sample Number 75 significantly decreased over time. Thus, the solid electrolyte of Sample Number 51 has more excellent atmospheric stability than the solid electrolyte of Sample Number 75. It should be noted that the solid electrolytes of Sample Number 51 (i.e., the example) and Sample Number 75 (i.e., the comparative example) both may include a trace amount of a pyrochlore phase that is not detectable by X-ray diffraction.

The reasons for the differences in properties between solid electrolytes containing Pr and solid electrolytes containing La and free of Pr, along with their effective actions, are described in detail below.

As described above, there is a tendency that, when a Li-based material is sintered at a high firing temperature, the evaporation of Li causes segregation of a Li-deficient crystalline phase (e.g., pyrochlore phase (La₂Zr₂O₇)) at the grain boundaries.

The segregated Li-deficient crystalline phase, even in a trace amount, is decomposed by reaction with at least one selected from the group consisting of moisture and carbon dioxide in the atmosphere. This causes the crystalline phase to expand. The expansion generates cracks between the crystal particles having a garnet-type crystal structure, and eventually, the sintered body collapses. On the other hand, the compacts of Sample Numbers 39 to 55, 57 to 62, 64 to 66, and 68 to 70 containing Bi and Pr as constituent elements in the examples were sintered at lower temperatures than the temperature at which a compact containing Bi and La is sintered. Consequently, the evaporation of the components contained in each of the compacts during sintering was suppressed, thereby improving the atmospheric stability of the solid electrolyte despite the fact that the sintered body has low density, that is, the sintered body is prone to the intrusion of moisture and the like. Thus, in the solid electrolytes of the examples containing Pr as a constituent element, the evaporation of the components contained in the compacts during sintering is suppressed, thereby improving atmospheric stability.

As shown in Table 4, the solid electrolytes of Sample Numbers 40 and 51 did not collapse even after being left for 500 hours at a temperature of 15° C. or more and 35° C. or less and a humidity of 50% or more and 80% or less. In contrast, the solid electrolyte of Sample Number 71 collapsed in 20 hours under the same conditions. The solid electrolyte of Sample Number 75 exhibited significantly decreased ionic conductivity after 500 hours. Thus, a solid electrolyte containing Pr has been found to have inherently much higher atmospheric stability than a solid electrolyte free of Pr.

Furthermore, as in the solid electrolyte of Sample Number 40, even in the case where a solid electrolyte includes a trace amount of a Pr—Zr-based pyrochlore phase between crystalline phases having a Pr-based garnet-type crystal structure, the solid electrolyte has high stability.

As described above, in the case where the Li content is in excess, that is, in the case where x2>0 is satisfied in the composition formula Li₇₍₁₊ₓ₂₎Pr₃Zr₂Bi_{y2}O_{12+3.5x2+1.5y2}, sintering and changes in crystalline phase are more likely to progress from lower temperatures than in the case where x2=0 is satisfied. Consequently, a cubic-system garnet-type crystal structure is stably formed and the ionic conductivity is also increased. For example, in Sample Number 50 (x2=0.2), the sintering temperature is 970° C., resulting in a solid electrolyte composed of a single phase of a cubic-system garnet-type crystal structure. The solid electrolyte has a good ionic conductivity of 6.7×10⁻⁴ S/cm at a density of 4.14 g/cm³. Furthermore, the solid electrolyte of Sample Number 55 (x2=0.35) has an ionic conductivity of 3.3×10⁻⁵ S/cm. In contrast, the solid electrolyte of Sample Number 54 (x2=0.3) has an ionic conductivity of 5.9×10⁻⁴ S/cm. The solid electrolyte of Sample Number 54 has higher ionic conductivity than the solid electrolyte of Sample Number 55. Therefore, in the case where the value of x2 is 0.3 or less, higher ionic conductivity can be achieved than in the case where the value of x2 exceeds 0.3. As described above, high Li content causes a fusion issue of the solid electrolyte due to excessive sintering in some cases. In the case where the value of x2 is 0.3 or less, the occurrence of fusion of the solid electrolyte is more reliably suppressed than in the case where the value of x2 exceeds 0.3.

In the composition formula Li₇₍₁₊ₓ₂₎Pr₃Zr₂Bi_{y2}O_{12+3.5x2+1.5y2}, the value of x2 is −0.05 or more and 0.35 or less. As described above, from the three viewpoints of decreasing the sintering temperature, improving the ionic conductivity, and suppressing the occurrence of a fusion issue due to excessive sintering, the value of x2 may be 0 or more and 0.35 or less or more than 0 and 0.3 or less.

Additionally, for the solid electrolyte of Sample Number 52, cubic-system garnet-type, Li₂ZrO₃, and PrO₂ crystal structures were detected by powder X-ray diffraction. This detection result suggests that a portion of the crystalline phase having a cubic-system garnet-type crystal structure is decomposed on the surface of the solid electrolyte. The solid electrolyte of Sample Number 52 has lower electrical conductivity than the solid electrolytes of Sample Numbers 50 and 51. It should be noted that the solid electrolytes of Sample Numbers 50 to 52 have the same chemical composition. The present inventors believe that the lower electrical conductivity of Sample Number 52 is due to its high Li content (i.e., x2=0.2) and the sintering of the compact at 1030° C., which is a higher temperature than those of Sample Numbers 50 and 51.

Additionally, the solid electrolyte is expected to exhibit a similar tendency in the case where at least one selected from the group consisting of As, Ge, and Te is used as M in place of Sb or Bi, particularly in the case where at least one selected from the group consisting of As and Te is used as M. This is because, in the compact according to the first embodiment, the presence of the low-melting M oxide causes the particle surfaces of the M oxide, wetted by the liquid phase, to act as an accelerator for sintering and a solid-phase reaction, resulting in the formation of a cubic-system garnet-type crystal structure at low temperature, similar to the case where Sb or Bi is contained.

The solid electrolyte of the present disclosure can be used, for example, in secondary batteries for electronic devices and automobiles. The electricity storage device of the present disclosure can be used, for example, as a secondary battery for various electronic devices and automobiles.

What is claimed is:

1. A solid electrolyte comprising Li, Pr, Zr, O, and M and comprising a crystalline phase having a garnet-type crystal structure, wherein
the M is at least one selected from the group consisting of Sb, Bi, As, Ge, and Te.

2. The solid electrolyte according to claim 1, wherein
the M comprises Sb.

3. The solid electrolyte according to claim 2, being represented by the following composition formula:
Li₇₍₁₊ₓ₁₎α1₃β1₂₊ₐ₁Sb_{y1}O_{12+3.5x1+1.5y1+b1} (1)
where
α1 comprises Pr,
β1 comprises Zr, and
−0.05≤x1≤0.35, 0<y1≤0.5, −0.5≤α1≤0.5, and −0.5≤b1≤0.5 are satisfied.

4. The solid electrolyte according to claim 3, wherein
in the composition formula (1),
0≤x1≤0.35 is satisfied.

5. The solid electrolyte according to claim 4, wherein
in the composition formula (1),
0≤x1≤0.3 is satisfied.

6. The solid electrolyte according to claim 5, wherein
in the composition formula (1),
0<x1≤0.3 is satisfied.

7. The solid electrolyte according to claim 3, wherein
a molar ratio of Pr to the entire α1 is 0.8 or more, and
a molar ratio of Zr to the entire β1 is 0.8 or more.

8. The solid electrolyte according to claim 7, wherein
the α1 is Pr, and
the β1 is Zr.

9. The solid electrolyte according to claim 3, wherein
in the composition formula (1), a1=0 and b1=0 are satisfied.

10. The solid electrolyte according to claim 2, wherein
the crystalline phase has a cubic-system garnet-type crystal structure.

11. The solid electrolyte according to claim 2, having a density of 2.7 g/cm³ or more and 4.2 g/cm³ or less.

12. The solid electrolyte according to claim 1, wherein
the M comprises Bi.

13. The solid electrolyte according to claim 12, being represented by the following composition formula (2):
Li₇₍₁₊ₓ₂₎α2₃β2₂₊ₐ₂Bi_{y2}O_{12+3.5x2+1.5y2+b2} (2)
where
α2 comprises Pr,
β2 comprises Zr, and
−0.05≤x2≤0.35, 0<y2≤0.4, −0.5≤α2≤0.5, and −0.5≤b2≤0.5 are satisfied.

14. The solid electrolyte according to claim 13, wherein
in the composition formula (2),
0≤x2≤0.35 is satisfied.

15. The solid electrolyte according to claim 14, wherein
in the composition formula (2),
0≤x2≤0.3 is satisfied.

16. The solid electrolyte according to claim 14, wherein
in the composition formula (2),
0<x2≤0.3 is satisfied.

17. The solid electrolyte according to claim 12, wherein
a molar ratio of Pr to the entire α2 is 0.8 or more, and
a molar ratio of Zr to the entire β2 is 0.8 or more.

18. The solid electrolyte according to claim 16, wherein
the α2 is Pr, and
the β2 is Zr.

19. The solid electrolyte according to claim 13, wherein
in the composition formula (2), a2=0 and b2=0 are satisfied.

20. The solid electrolyte according to claim 12, wherein
the crystalline phase has a cubic-system garnet-type crystal structure.

21. The solid electrolyte according to claim 12, having a density of 3.76 g/cm³ or more and 4.27 g/cm³ or less.

22. An electricity storage device comprising:
a first electrode;
a second electrode; and
the solid electrolyte according to claim 1.

23. The electricity storage device according to claim 22, wherein
at least one selected from the group consisting of the first electrode and the second electrode comprises a metal having a melting point of less than 1050° C.

24. The electricity storage device according to claim 23, wherein
the metal is a Ag—Pd alloy.

25. The electricity storage device according to claim 22, wherein
at least one selected from the group consisting of the first electrode and the second electrode is composed of a Ag—Pd alloy, and
a molar ratio of Ag to Pd in the Ag—Pd alloy is more than 80/20.

26. The electricity storage device according to claim 22, wherein
at least one selected from the group consisting of the first electrode and the second electrode is composed of Ag.

27. The electricity storage device according to claim 22, being a battery or a multilayer capacitor.

28. The electricity storage device according to claim 27, wherein
the electricity storage device is a battery,
the battery further comprises an electrolyte layer provided between the first electrode and the second electrode, and
at least one selected from the group consisting of the first electrode, the second electrode, and the electrolyte layer comprises the solid electrolyte.

29. The electricity storage device according to claim 28, wherein
the electrolyte layer comprises the solid electrolyte.

30. A method for manufacturing a solid electrolyte, the method comprising:
mixing raw materials comprising an oxide comprising Li, an oxide comprising Pr, an oxide comprising Zr, and an oxide of M;
obtaining a compact of a mixture resulting from the mixing; and
sintering the compact, wherein
the M is at least one selected from the group consisting of Sb, Bi, As, Ge, and Te.

31. The method according to claim 30, wherein
the M comprises Sb.

32. The method according to claim 30, wherein
the M comprises Bi.
